(19) United States
(12) Patent Application Publication
(10) Pub. No.: US 2017/0155800 A1
(43) Pub. Date: Jun. 1, 2017

(54) COMMUNICATION APPARATUS, RECORDING MEDIUM, AND COMMUNICATION SYSTEM

(71) Applicant: Konica Minolta, Inc., Tokyo (JP)

(72) Inventor: Kenichi NAGASAWA, Osaka (JP)

(73) Assignee: Konica Minolta, Inc., Tokyo (JP)

(21) Appl. No.: 15/361,800

(22) Filed: Nov. 28, 2016

(30) Foreign Application Priority Data
Nov. 30, 2015 (JP) 2015-233820

(51) Int. Cl. H04N 1/44; H04N 1/00; H04N 1/32; G06F 21/32

(52) U.S. Cl. CPC H04N 1/442; G06F 21/32; H04N 1/4433; H04N 1/00307; H04N 1/32117; H04N 2201/0094; H04N 2201/3205; H04N 2201/3236

(57) ABSTRACT

A communication apparatus capable of determining whether to permit a login to an image forming apparatus by a carrying user of a portable terminal acquires an authentication result of a terminal authentication performed on the basis of terminal authentication information stored in the portable terminal and authorized terminal authentication information and receives, from the portable terminal, an authentication result of a biometric authentication which is performed in the portable terminal on the basis of biometric authentication information acquired from the carrying user of the portable terminal and biometric authentication information of an authorized user of the portable terminal. The communication apparatus permits the login to the image forming apparatus by the carrying user on the condition that the terminal authentication is successful and the authentication result indicating that the biometric authentication is successful is received from the portable terminal.

This application is based on Japanese Patent Application No. 2015-233820 filed on Nov. 30, 2015, the contents of which are hereby incorporated by reference.

### BACKGROUND OF THE INVENTION

### Field of the Invention

The present invention relates to a communication system comprising an image forming apparatus such as an MFP (Multi-Functional Peripheral) or the like, and its relevant technique.

### Description of the Background Art

In an image forming apparatus, a technique for performing an authentication by using authentication information received from a portable terminal has been used.

In Japanese Patent Application Laid Open Gazette No. 2006-93875 (Patent Document 1), for example, in order to use an image forming apparatus, a portable terminal displays thereon an input screen for authentication information (for example, a user ID and a password) and requests a user of the portable terminal to input the authentication information. Then, the portable terminal transmits the authentication information inputted by the user to the image forming apparatus. When the image forming apparatus receives the authentication information from the portable terminal, the image forming apparatus performs an authentication by checking (comparing) the authentication information transmitted from the portable terminal against (with) authorized authentication information stored in a database thereof, and when the authentication is successful, the image forming apparatus permits a use of (a login to) the self-apparatus.

Herein, there is a possible case where an authorized user (owner) of the portable terminal registers the authentication information used for the authentication in his portable terminal in advance and when a login is made to the image forming apparatus, the portable terminal automatically transmits the authentication information stored in the self-device to the image forming apparatus, without requesting the authorized user to input the authentication information. Then, the image forming apparatus automatically performs the authentication on the basis of the authentication information transmitted from the portable terminal and the authorized authentication information, and when the authentication information is successful, the authorized user of the portable terminal is permitted to log in to the image forming apparatus. With this technique, it is possible for the authorized user of the portable terminal to eliminate the necessity of inputting the authentication information for the login to the image forming apparatus and obtain great convenience if the authorized user registers the authentication information in his portable terminal in advance. Further, the authentication process using the authentication information (terminal authentication information) stored in the portable terminal is also referred to as a “terminal authentication”.

When a login process to the image forming apparatus is performed only by the terminal authentication, however, since the terminal authentication information stored in the portable terminal is transmitted without requesting a carrying user who has the portable terminal to input authentication information, there is a possibility that a third party (unauthorized user) other than the authorized user of the portable terminal may spoof the authorized user and log in to the image forming apparatus.

In a case where the authorized user (for example, a user U1) of the portable terminal lost his portable terminal and a stranger other than the user U1 picked up the portable terminal of the user U1, for example, there is a possibility that the stranger may use the portable terminal of the user U1 (in other words, spoof the user U1) and log in to the image forming apparatus.

Specifically, when the stranger who picked up the portable terminal of the user U1 intends to log in to the image forming apparatus by using the portable terminal of the user U1, without requesting the stranger to input the authentication information, the terminal authentication information of the user U1 which is stored in the portable terminal is automatically transmitted to the image forming apparatus. Then, the image forming apparatus checks the terminal authentication information transmitted from the portable terminal against the authorized terminal authentication information, to thereby automatically perform the terminal authentication process. As a result, though the carrying user who currently has the portable terminal is the stranger who is different from the user U1, the image forming apparatus permits the login by the stranger by recognizing the login as a login by the user U1.

Thus, when the login process to the image forming apparatus is performed only by the terminal authentication, there is a possibility that a spoofing login may be performed by a third party other than the authorized user of the portable terminal.

### SUMMARY OF THE INVENTION

It is an object of the present invention to provide a technique which makes it possible to avoid a spoofing login to an image forming apparatus by a third party other than an authorized user of a portable terminal.

The present invention is intended for a communication apparatus capable of determining whether to permit a login to an image forming apparatus by a carrying user of a portable terminal. According to a first aspect of the present invention, the communication apparatus comprises an acquisition part for acquiring an authentication result of a terminal authentication performed on the basis of terminal authentication information stored in the portable terminal and authorized terminal authentication information and receiving, from the portable terminal, an authentication result of a biometric authentication which is performed in the portable terminal on the basis of biometric authentication information acquired from the carrying user of the portable terminal and biometric authentication information of an authorized user of the portable terminal and a permission part for permitting the login to the image forming apparatus by the carrying user on the condition that the terminal authentication is successful and the authentication result indicating that the biometric authentication is successful is received from the portable terminal.

The present invention is also intended for a communication system. According to a second aspect of the present invention, the communication system comprises a communication apparatus as defined in the first aspect and the portable terminal.

The present invention is still also intended for a non-transitory computer-readable recording medium. According to a third aspect of the present invention, the non-transitory computer-readable recording medium records therein a computer program to be executed by a computer embedded in a communication apparatus capable of determining whether to permit a login to an image forming apparatus by a carrying user of a portable terminal, to cause the computer to perform the steps of a) acquiring an authentication result of a terminal authentication performed on the basis of terminal authentication information stored in the portable terminal and authorized terminal authentication information and receiving, from the portable terminal, an authentication result of a biometric authentication which is performed in the portable terminal on the basis of biometric authentication information acquired from the carrying user of the portable terminal and biometric authentication information of an authorized user of the portable terminal and b) permitting the login to the image forming apparatus by the carrying user on the condition that the terminal authentication is successful and the authentication result indicating that the biometric authentication is successful is received from the portable terminal.

According to a fourth aspect of the present invention, the communication apparatus comprises an acquisition part for acquiring an authentication result of a terminal authentication performed on the basis of terminal authentication information stored in the portable terminal and authorized terminal authentication information and acquiring an authentication result of a biometric authentication performed in the communication apparatus on the basis of biometric authentication information received from the portable terminal, which is biometric authentication information acquired from the carrying user of the portable terminal, and biometric authentication information of an authorized user of the portable terminal and a permission part for permitting the login to the image forming apparatus by the carrying user on the condition that the terminal authentication is successful and the biometric authentication is also successful.

According to a fifth aspect of the present invention, the communication system comprises a communication apparatus as defined in the fourth aspect and the portable terminal.

According to a sixth aspect of the present invention, the non-transitory computer-readable recording medium records therein a computer program to be executed by a computer embedded in a communication apparatus capable of determining whether to permit a login to an image forming apparatus by a carrying user of a portable terminal, to cause the computer to perform the steps of a) acquiring an authentication result of a terminal authentication performed on the basis of terminal authentication information stored in the portable terminal and authorized terminal authentication information and acquiring an authentication result of a biometric authentication performed in the communication apparatus on the basis of biometric authentication information received from the portable terminal, which is biometric authentication information acquired from the carrying user of the portable terminal, and biometric authentication information of an authorized user of the portable terminal and b) permitting the login to the image forming apparatus by the carrying user on the condition that the terminal authentication is successful and the biometric authentication is also successful.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a communication system;

FIG. 2 is a view showing functional blocks of an image forming apparatus (MFP);

FIG. 3 is a functional block diagram showing a schematic constitution of a portable terminal;

FIG. 4 is a graph showing a time variation and the like in the radio field intensity;

FIG. 5 is a view showing a manner in which the portable terminal comes closer to the MFP;

FIG. 6 is a view showing a concept of operations and the like in the communication system;

FIG. 7 is a flowchart showing an operation of the portable terminal;

FIG. 8 is a flowchart showing an operation of the MFP;

FIG. 9 is a timing chart showing an exemplary operation of the communication system;

FIG. 10 is a view showing a terminal management table;

FIG. 11 is a view showing a message screen;

FIG. 12 is a view showing a menu screen;

FIG. 13 is a view showing an input screen;

FIG. 14 is a view showing a biometric authentication setting screen;

FIG. 15 is a view showing a biometric authentication setting management table;

FIG. 16 is a view showing a communication system in accordance with a third preferred embodiment;

FIG. 17 is a view showing functional blocks of an external server;

FIG. 18 is a timing chart showing an exemplary operation of the communication system in accordance with the third preferred embodiment;

FIG. 19 is a flowchart showing an operation of the portable terminal in accordance with a fourth preferred embodiment;

FIG. 20 is a flowchart showing an operation of the MFP in accordance with the fourth preferred embodiment; and

FIG. 21 is a timing chart showing an exemplary operation of the communication system in accordance with the fourth preferred embodiment.

### DESCRIPTION OF THE PREFERRED EMBODIMENTS

Hereinafter, the preferred embodiments of the present invention will be described with reference to the accompanying drawings.

### 1. The First Preferred Embodiment

<1-1. Overall Configuration>

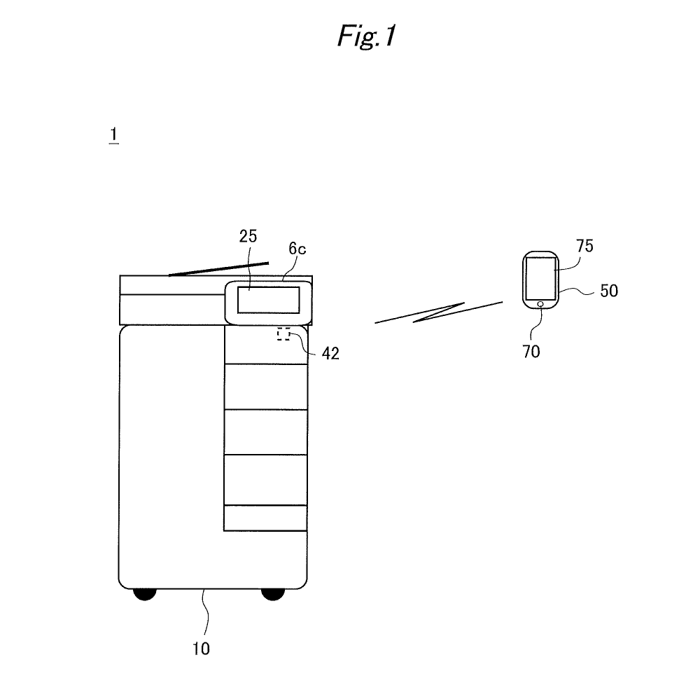

FIG. 1 is a view showing a communication system (authentication system) 1 in accordance with the present invention. As shown in FIG. 1, the communication system 1 comprises an MFP (image forming apparatus) 10 and a portable terminal 50. Herein, as a communication apparatus (authentication apparatus), the MFP 10 is exemplarily shown. Further, the communication system 1 is also referred to as an image forming system.

The MFP 10 and the portable terminal 50 are connected to each other via wireless communication by using various wireless communication technologies. For the communication between the MFP 10 and the portable terminal 50, for example, a communication with wireless LAN (IEEE 802.11 or the like) and a short-range wireless communication can be used. In the present preferred embodiment, as the short-range wireless communication, a communication (BLE communication) in accordance with BLE (Bluetooth Low Energy) which is an extended standard of the Bluetooth (registered trademark) is used, and a wireless communication between the portable terminal 50 and the MFP 10 is performed.

Further, in this communication system 1, when a login to the MFP 10 is performed by using the portable terminal 50, at least two types of different authentications, i.e., a “terminal authentication” and a “biometric authentication”, are performed. The portable terminal 50 is owned by one authorized user (for example, a user U1). In the portable terminal 50, registered are terminal authentication information (authentication information used for the terminal authentication) of only the authorized user (user U1) and biometric authentication information (authentication information of the authorized user in the biometric authentication) of the authorized user (user U1).

The “terminal authentication” (also referred to as a terminal automatic authentication) is an authentication process accompanied with the communication (herein, the BLE communication) between the portable terminal 50 and the MFP 10. In the “terminal authentication”, a carrying user of the portable terminal 50 (an operating user who operates the portable terminal 50) is not requested to perform an input operation (manual input operation) of the authentication information, and the authentication information (terminal authentication information) stored in the portable terminal 50 is used. Herein, the MFP 10 performs the terminal authentication.

Specifically, the portable terminal 50 automatically transmits the terminal authentication information (for example, a user ID and a password) which is registered in the self-device in advance, to the MFP 10. When the MFP 10 receives the terminal authentication information from the portable terminal 50, the MFP 10 checks (compares) this terminal authentication information against (with) authorized terminal authentication information stored in the MFP 10, to thereby automatically perform the terminal authentication (terminal authentication process). Then, when there is the authorized terminal authentication information which coincides with the terminal authentication information received from the portable terminal 50, the MFP 10 determines that the terminal authentication is successful. On the other hand, when there is no authorized terminal authentication information which coincides with the terminal authentication information received from the portable terminal 50, the MFP 10 determines that the terminal authentication fails.

The “biometric authentication” is an authentication process of authenticating (identifying) an individual on the basis of the biometric characteristics of human (biometric information such as a fingerprint and the like). As the biometric authentication, used are a fingerprint authentication using fingerprints of fingers and the like of human, an iris authentication using a radial pattern in an iris of an eye of human, a face authentication using the characteristics (for example, shapes, positions, contours, and the like of an eye, a nose, and the like) of a face of human, and the like. Herein, as the biometric authentication, the fingerprint authentication is performed in the portable terminal 50.

In the fingerprint authentication, when a finger of an authentication target person (the carrying user (operating user) of the portable terminal 50) is placed on a predetermined position (e.g, a button 70 around a touch panel 75 of the portable terminal 50 (see FIG. 1)) in which a sensor for reading the fingerprint, for example, is embedded, the fingerprint of the finger is read. Then, by checking (comparing) fingerprint information (biometric authentication information) which is read against (with) fingerprint information (biometric authentication information of the authorized user) of the authorized user of the portable terminal 50, which is stored in the portable terminal 50, the fingerprint authentication (fingerprint authentication process) is performed. When the biometric authentication information read from the carrying user coincides with the biometric authentication information of the authorized user of the portable terminal 50 on a predetermined level or more, it is determined that the biometric authentication is successful. In other words, it is determined that the authentication target person of the biometric authentication (the carrying user of the portable terminal 50) is the true authorized user of the portable terminal 50. On the other hand, when the biometric authentication information read from the carrying user does not coincide with the biometric authentication information of the authorized user of the portable terminal 50 on the predetermined level, it is determined that the biometric authentication fails. In other words, it is determined that the authentication target person of the biometric authentication (the carrying user of the portable terminal 50) is not the true authorized user of the portable terminal 50. By performing the biometric authentication, the portable terminal 50 can check if the authentication target person of the biometric authentication (the carrying user who currently has (operates) the portable terminal 50) is the true authorized user (true owner) of the portable terminal 50.

<1-2. Constitution of Image Forming Apparatus>

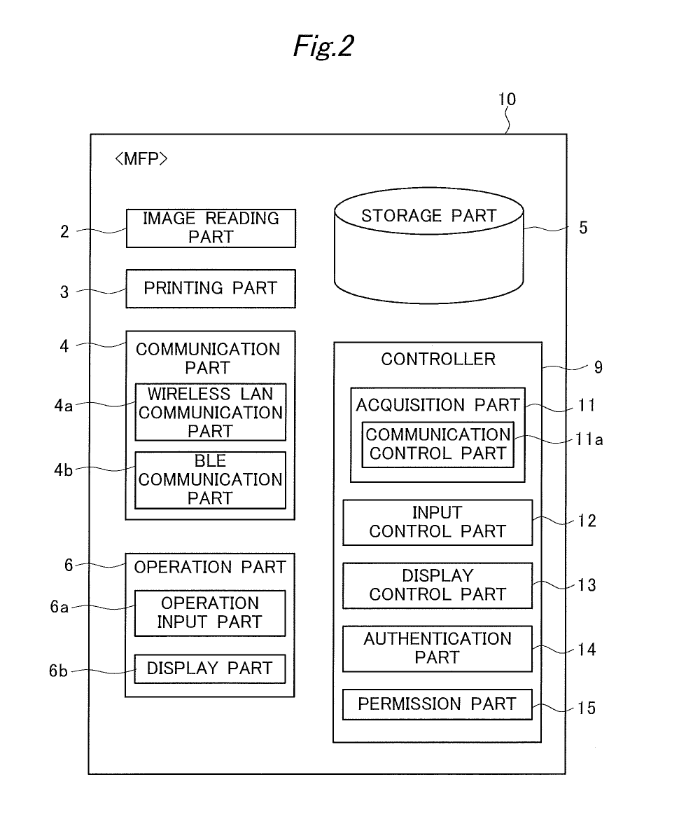

FIG. 2 is a view showing function blocks of the image forming apparatus 10. Herein, as the image forming apparatus 10, exemplarily shown is an MFP (Multi-Functional Peripheral). FIG. 2 shows function blocks of the MFP 10.

The MFP 10 is an apparatus (also referred to as a multifunction machine) having a scanner function, a copy function, a facsimile function, a box storage function, and the like. Specifically, as shown in the functional block diagram of FIG. 2, the MFP 10 comprises an image reading part 2, a printing part 3, a communication part 4, a storage part 5, an operation part 6, a controller (control part) 9, and the like, and multiply uses these constituent parts to implement various functions.

The image reading part 2 is a processing part which optically reads (in other words, scans) an original manuscript placed on a predetermined position of the MFP 10 and generates image data of the original manuscript (also referred to as an “original manuscript image” or a “scan image”). The image reading part 2 is also referred to as a scanning part.

The printing part 3 is an output part which prints out an image to various media such as paper on the basis of the data on an object to be printed.

The communication part 4 is a processing part capable of performing facsimile communication via public networks or the like. Further, the communication part 4 is capable of performing various wireless communications (including a wireless communication in accordance with the BLE, and the like). Specifically, the communication part 4 comprises a wireless LAN communication part 4a for performing a wireless communication in accordance with the wireless LAN (IEEE 802.11 or the like) and a BLE communication part 4b for performing a wireless communication in accordance with the BLE. The MFP 10 incorporates a BLE chip 42 (also referred to as a chip for short-range wireless communication (or simply as a communication chip)) which serves as the whole of or part of the BLE communication part 4b (also see FIG. 1). The BLE chip 42 is capable of performing broadcast transmission of advertising data (transmission data to be broadcast-transmitted).

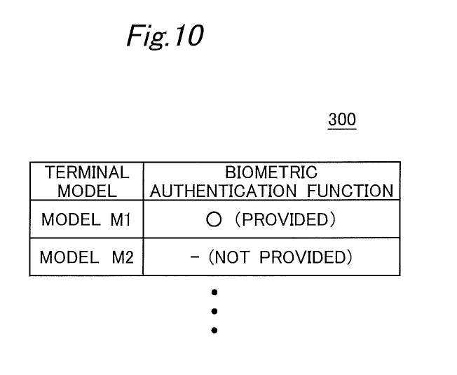

The storage part 5 is a storage unit such as a hard disk drive (HDD) or/and the like. In the storage part 5, registered (stored) is authorized authentication information (authorized terminal authentication information) (herein, the user ID and the password) used in the terminal authentication. Further, in the storage part 5, also registered (stored) is terminal management information (a terminal management table 300) (see FIG. 10) which manages whether a biometric authentication function is provided or not, for each terminal model (model of the portable terminal).

The operation part 6 comprises an operation input part 6a for receiving an operation input which is given to the MFP 10 and a display part 6b for displaying various information thereon.

The MFP 10 is provided with a substantially plate-like operation panel part 6c (see FIG. 1). The operation panel part 6c has a touch panel 25 (see FIG. 1) on a front surface side thereof. The touch panel 25 serves as part of the operation input part 6a and also serves as part of the display part 6b. The touch panel 25 is a liquid crystal display panel in which various sensors or the like are embedded, and capable of displaying various information thereon and receiving various operation inputs from the operating user.

The controller (control part) 9 is a control unit for generally controlling the MFP 10. The controller 9 is a computer system which is embedded in the MFP 10 and comprises a CPU, various semiconductor memories (RAM and ROM), and the like. The controller 9 causes the CPU to execute a predetermined software program (hereinafter, also referred to simply as a program) stored in the ROM (e.g., EEPROM (registered trademark)), to thereby implement various processing parts. Further, the program (in more detail, a group of program modules) may be recorded in one of various portable recording media (in other words, various non-transitory computer-readable recording media), such as a USB memory or the like, and read out from the recording medium to be installed in the MFP 10. Alternatively, the program may be downloaded via the wireless LAN or the like to be installed in the MFP 10.

Specifically, as shown in FIG. 2, the controller 9 executes the above-described program, to thereby implement various processing parts including an acquisition part 11, an input control part 12, a display control part 13, an authentication part 14, and a permission part 15.

The acquisition part 11 is a processing part for controlling an operation of acquiring various information, or the like. For example, the acquisition part 11 acquires an authentication result (terminal authentication result) of the terminal authentication performed in the MFP 10, and also acquires an authentication result (the biometric authentication result) of the biometric authentication performed in the portable terminal 50 by using a communication control part 11a (described below). The acquisition part 11 has the communication control part 11a.

The communication control part 11a is a processing part for controlling a communication with other apparatus(es) (the portable terminal 50 or/and the like) in cooperation with the communication part 4 and the like. The communication control part 11a has a transmission control part for controlling a transmitting operation of various data and a reception control part for controlling a receiving operation of various data. For example, in cooperation with the communication part 4, the communication control part 11a receives a login request to the self-apparatus from the portable terminal 50 (through the BLE communication) and transmits a transmission request of the terminal authentication information and a biometric authentication request (described later) to the portable terminal 50 through the BLE communication. Further, in cooperation with the communication part 4, the communication control part 11a receives the authentication result (the biometric authentication result) of the biometric authentication performed in the portable terminal 50 and the terminal authentication information, from the portable terminal 50 through the BLE communication.

The input control part 12 is a control part for controlling an operation inputting operation to the operation input part 6a (the touch panel 25 or the like). For example, the input control part 12 controls an operation for receiving an operation input to an operation screen displayed on the touch panel 25.

The display control part 13 is a processing part for controlling a display operation on the display part 6b (the touch panel 25 or the like). The display control part 13 displays the operation screen or the like for operating the MFP 10 on the touch panel 25.

The authentication part 14 is a processing part for controlling an operation of performing the terminal authentication (terminal authentication process), and the like. Specifically, the authentication part 14 checks (compares) the terminal authentication information received from the portable terminal 50 against (with) the authorized terminal authentication information stored in the self-device (storage part 5), to thereby perform the terminal authentication.

The permission part 15 is a processing part for controlling an operation of determining whether to permit the login to the MFP 10 by the carrying user of the portable terminal 50, and the like. For example, the permission part 15 permits the login to the MFP 10 by the carrying user of the portable terminal 50 on the condition that the terminal authentication is successful in the MFP 10 and the biometric authentication of the carrying user of the portable terminal 50 is successful in the portable terminal 50. On the other hand, when the terminal authentication fails or the biometric authentication fails, the permission part 15 rejects the login to the MFP 10 by the carrying user.

<1-3. Constitution of Portable Terminal>

The portable terminal 50 is a device which is capable of performing a cooperative operation with the MFP 10.

A constitution of the portable terminal 50 will be described.

The portable terminal (external terminal) 50 is an information input/output terminal device (information terminal) capable of performing network communication with the MFP 10. Herein, as the portable terminal 50, exemplarily shown is a smartphone. The portable terminal 50, however, is not limited to this but may be a tablet terminal or the like.

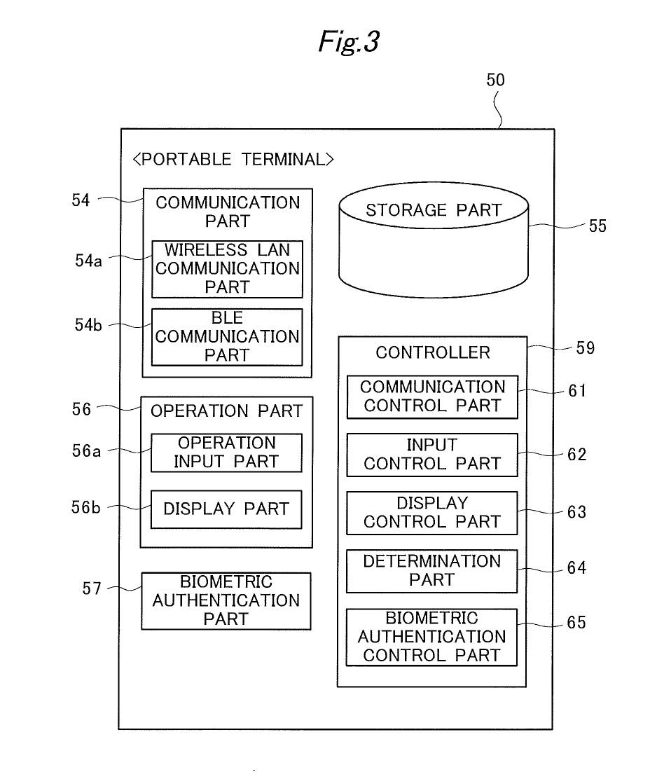

FIG. 3 is a functional block diagram showing a schematic constitution of the portable terminal 50.

As shown in the functional block diagram of FIG. 3, the portable terminal 50 comprises a communication part 54, a storage part 55, an operation part 56, a controller (control part) 59, and the like and multiply uses these constituent parts to implement various functions.

The communication part 54 is capable of performing various wireless communications (including a wireless communication in accordance with the BLE, and the like). Specifically, the communication part 54 comprises a wireless LAN communication part 54a for performing a wireless communication in accordance with the wireless LAN (IEEE 802.11 or the like) and a BLE communication part 54b for performing a wireless communication in accordance with the BLE. The BLE communication part 54b receives the advertising data broadcast-transmitted from the BLE chip 42 incorporated in the MFP 10 and measures the intensity of radio wave for data transmission.

The storage part 55 is a storage unit such as a nonvolatile semiconductor memory or the like. In the storage part 55, for example, the terminal authentication information (herein, the user ID and the password) used for the terminal authentication is stored in advance. Further, in the storage part 55, the biometric authentication information (for example, the fingerprint information of the user U1) of the authorized user used for the biometric authentication is also stored in advance. Furthermore, it is assumed that the terminal authentication information and the biometric authentication information of the authorized user which are registered in the portable terminal 50 are managed by the authorized user (user U1) of the portable terminal 50 with the password or the like and any person other than the authorized user (user U1) is not allowed to rewrite these authentication information.

The operation part 56 comprises an operation input part 56a for receiving an operation input which is given to the portable terminal 50 and a display part 56b for displaying various information thereon. The portable terminal 50 is provided with a touch panel 75 (see FIG. 1) which is a liquid crystal display panel in which various sensors or the like are embedded. The touch panel 75 serves as part of the operation input part 56a and also serves as part of the display part 56b.

A biometric authentication part 57 is capable of performing a biometric authentication of an authentication target person (the carrying user of the portable terminal 50) and is formed of a sensor (e.g., a fingerprint reader sensor) which is capable of reading the biometric information (e.g., fingerprint information) of the authentication target person in the biometric authentication, or the like. The biometric authentication part 57 is embedded in, for example, the button 70 around the touch panel 75 of the portable terminal 50 (see FIG. 1).

Further, in the portable terminal 50, a software program (also referred to as a biometric authentication program) used for performing the biometric authentication using the biometric authentication part 57 is installed in advance (preinstalled).

The controller (control part) 59 shown in FIG. 3 is a control unit for generally controlling the portable terminal 50. The controller 59 is a computer system which is embedded in the portable terminal 50 and comprises a CPU, various semiconductor memories (RAM and ROM), and the like. The controller 59 causes the CPU to execute a predetermined software program (hereinafter, also referred to simply as a program) stored in a memory part (such as a semiconductor memory or the like), to thereby implement various processing parts. Further, the program (in more detail, a group of program modules) may be recorded in one of various portable recording media (in other words, non-transitory computer-readable recording media), such as a USB memory or the like, and read out from the recording medium to be installed in the portable terminal 50. Alternatively, the program may be downloaded via the wireless LAN or the like to be installed in the portable terminal 50.

Specifically, the controller 59 executes the program or the like, to thereby implement various processing parts including a communication control part 61, an input control part 62, a display control part 63, a determination part 64, and a biometric authentication control part 65.

The communication control part 61 is a processing part for controlling a communication with the MFP 10 or/and the like in cooperation with the communication part 54 and the like. For example, in cooperation with the communication part 54 and the like, the communication control part 61 controls operations of transmitting the login request to the MFP 10, through the BLE communication to the MFP 10, and receiving the transmission request of the terminal authentication information and the biometric authentication request (described later) from the MFP 10 through the BLE communication. Further, in cooperation with the communication part 54 and the like, the communication control part 61 also controls an operation of transmitting the authentication result of the biometric authentication (the biometric authentication result) and the terminal authentication information stored in the self-device to the MFP 10 through the BLE communication.

The input control part 62 is a control part for controlling an operation inputting operation or the like to the operation input part 56a (the touch panel 75 or the like).

The display control part 63 is a processing part for controlling a display operation on the display part 56b (the touch panel 75 or the like).

The determination part 64 is a processing part for performing a process for determining that the portable terminal 50 has come close to the MFP 10 to a certain degree on the basis of a certain criterion (a process for detecting the proximity to the MFP 10).

The biometric authentication control part 65 is a processing part for controlling an operation of performing the biometric authentication (biometric authentication process) of the authentication target person (the carrying user of the portable terminal 50), and the like, in cooperation with the biometric authentication part 57 (the biometric authentication program). The biometric authentication control part 65 performs the biometric authentication by using the biometric authentication part 57 in response to the biometric authentication request from the MFP 10.

<1-4. Operation>

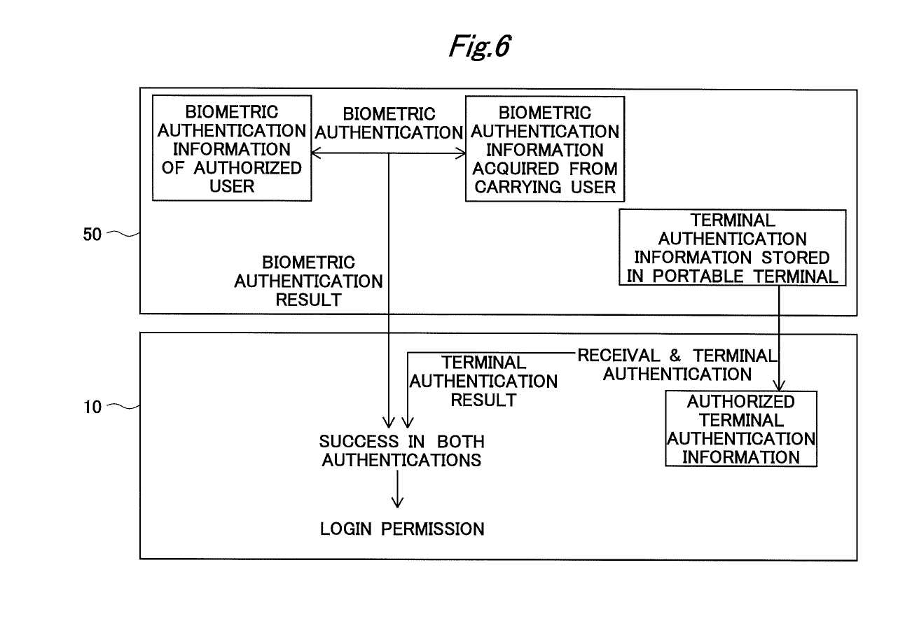

In this communication system 1, by using the communication (herein, the BLE communication) between the portable terminal 50 and the MFP 10, at least two types of authentications, i.e., the terminal authentication and the biometric authentication, are performed. Specifically, for the login to the MFP 10, the biometric authentication of the carrying user of the portable terminal 50 is performed in the portable terminal 50 and the terminal authentication is performed in the MFP 10 (see FIG. 6). Then, the MFP 10 permits the login to the self-apparatus by the carrying user on the condition that both the terminal authentication and the biometric authentication are successful (see FIG. 6).

Specifically, when the MFP 10 receives the login request to the self-apparatus from the portable terminal 50, the MFP 10 transmits the biometric authentication request for requesting the execution of the biometric authentication by the portable terminal 50 and the transmission request of the terminal authentication information to the portable terminal 50. In response to the biometric authentication request, the portable terminal 50 performs the biometric authentication based on the biometric authentication information acquired from the carrying user of the portable terminal 50 and the biometric authentication information of the authorized user which is stored in the self-device (portable terminal 50). When the biometric authentication is completed, the portable terminal 50 transmits the authentication result of the biometric authentication (the biometric authentication result) and the terminal authentication information stored in the self-device to the MFP 10. The MFP 10 performs the terminal authentication based on the terminal authentication information transmitted from the portable terminal 50 and the authorized terminal authentication information stored in the self-apparatus (MFP 10) and acquires the authentication result of the terminal authentication (the terminal authentication result). Then, the MFP 10 permits the login to the self-apparatus by the carrying user of the portable terminal 50 on the condition that the terminal authentication performed in the MFP 10 is successful and the biometric authentication performed in the portable terminal 50 is successful.

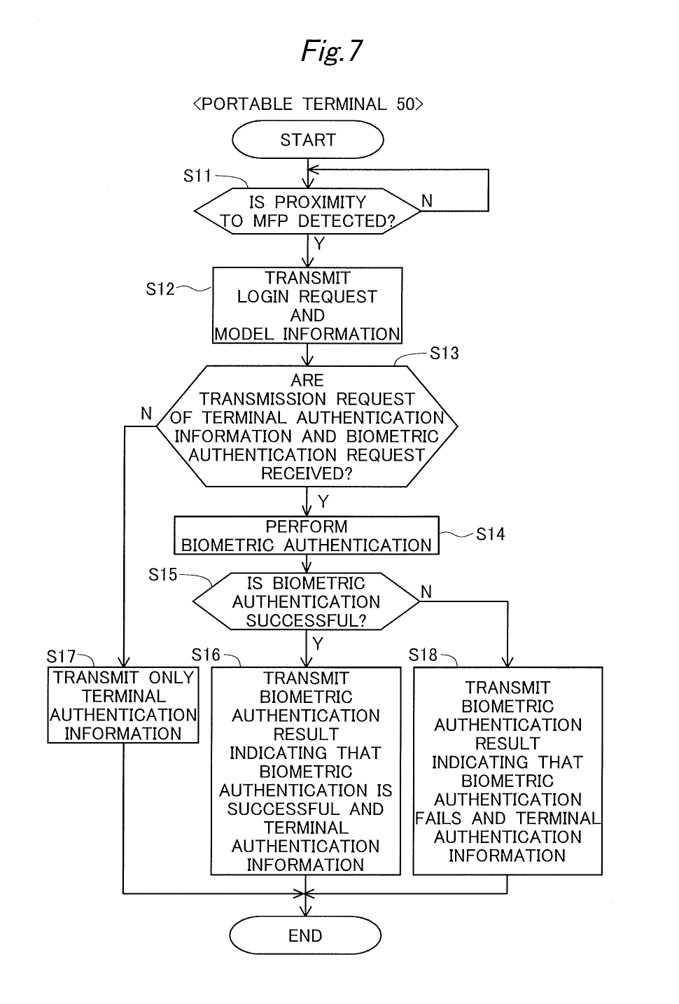

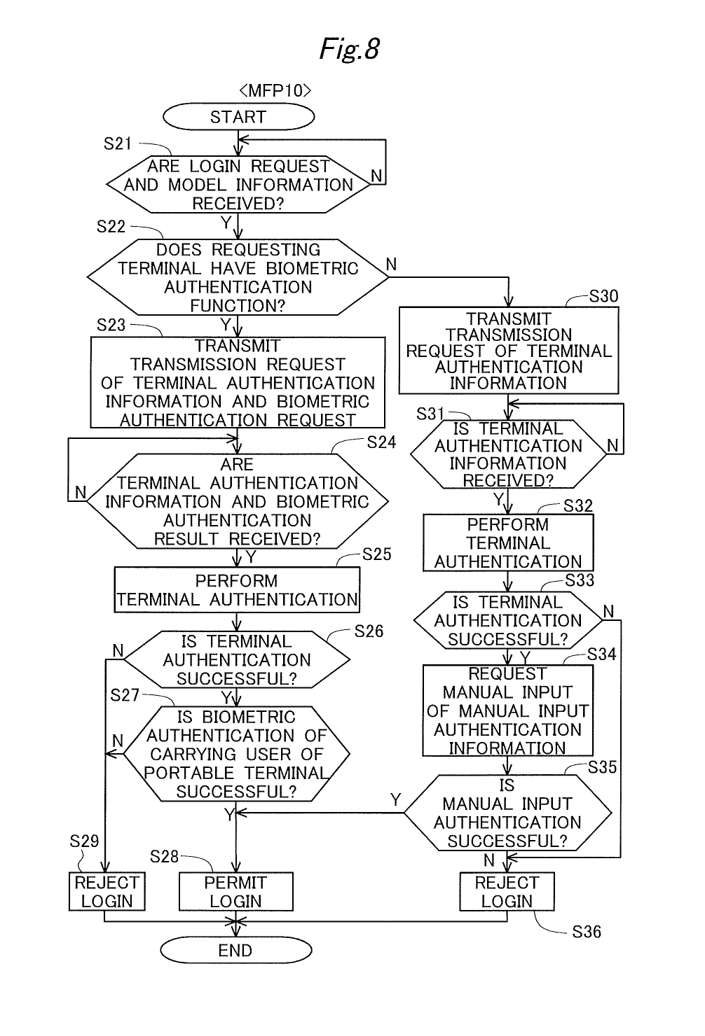

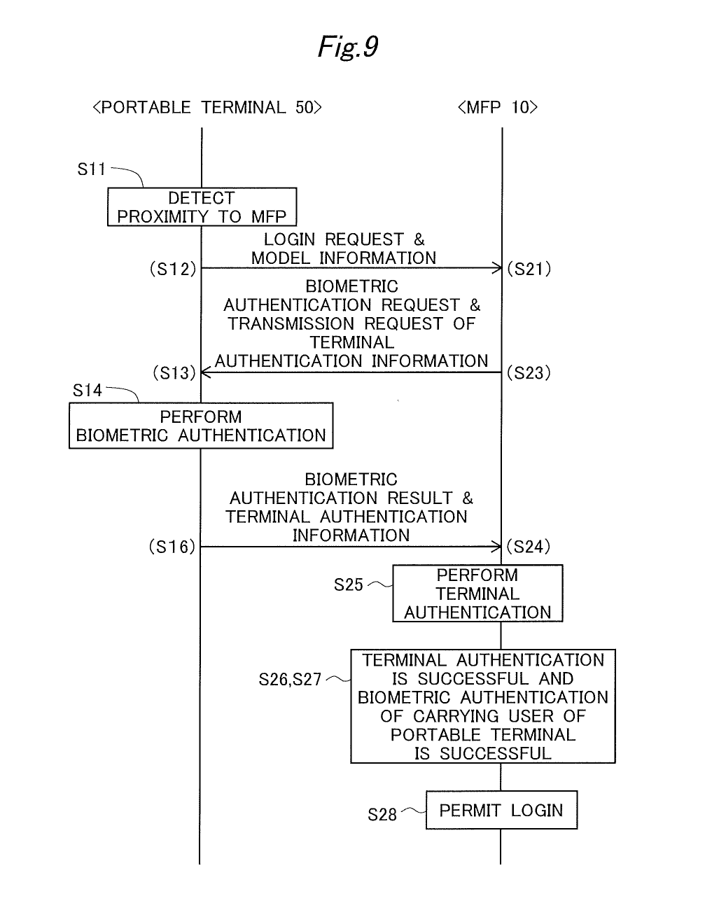

FIG. 7 is a flowchart showing an operation of the portable terminal 50, and FIG. 8 is a flowchart showing an operation of the MFP 10. Further, FIG. 9 is a timing chart showing an exemplary operation of the communication system 1. Hereinafter, with respect to FIGS. 7 to 9, the operation of the communication system 1 will be described.

Furthermore, in the present preferred embodiment, as described above, the BLE communication is used for the communication between the portable terminal 50 and the MFP 10.

First, as a precondition for the process shown in FIG. 7 and the process shown in FIG. 8, the MFP 10 always sends a radio wave for BLE communication at an infinitesimal time interval. Specifically, the BLE chip 42 incorporated in the MFP 10 (see FIG. 1) performs broadcast transmission of advertising data at the infinitesimal time interval. The radio wave for BLE communication reaches only a surrounding area (for example, in a range from several tens of centimeters to several meters) of the MFP 10.

On the other hand, the portable terminal 50 receives the radio wave for BLE communication from the MFP 10 and measures the intensity of the radio wave from the MFP 10. Specifically, the BLE communication part 54b of the portable terminal 50 receives the advertising data broadcast-transmitted from the BLE chip 42 and measures the intensity of the radio wave for data transmission.

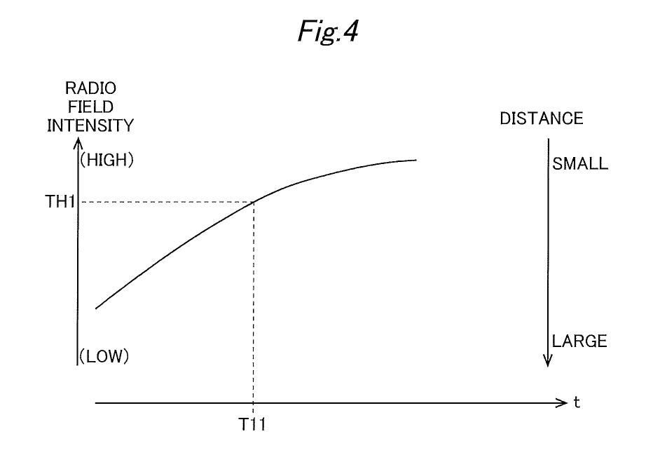

As the portable terminal 50 comes closer to the MFP 10 (in other words, as the distance between the portable terminal 50 and the MFP 10 becomes smaller) with an approaching operation of the portable terminal 50, the radio field intensity which is detected by the portable terminal 50 (the intensity of the BLE radio wave sent out from the MFP 10) increases (see FIG. 4). Conversely, as the portable terminal 50 moves farther away from the MFP 10 (in other words, as the distance between the portable terminal 50 and the MFP 10 becomes larger), the radio field intensity which is detected by the portable terminal 50 decreases.

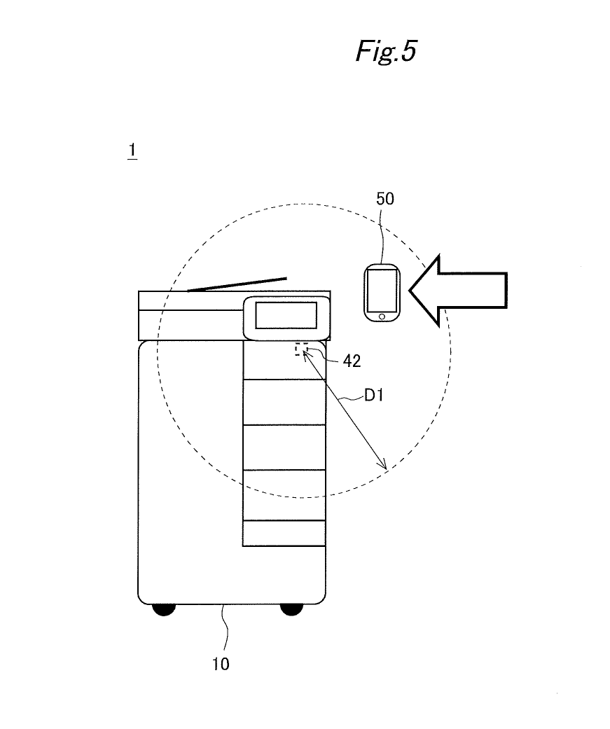

By using such characteristics, when the radio field intensity detected by the portable terminal 50 changes (increases) to a value exceeding a predetermined threshold value TH1, the portable terminal 50 determines that the proximity of the self-device to the MFP 10 is detected (Step S11 of FIG. 7) (also see FIG. 9). Specifically, it is determined that the distance between the portable terminal 50 and the MFP 10 (in more detail, a location of the BLE chip 42 in the MFP 10) is a distance within a predetermined range (e.g., 20 cm (centimeters)) (a distance not larger than a predetermined value D1) (see FIG. 5). Further, a value of the radio field intensity at the time when the distance between the portable terminal 50 and the MFP 10 becomes closer to the distance D1 (e.g., about 20 cm) may be measured in advance and the measured value may be determined as the threshold value TH1.

When the proximity to the MFP 10 is detected (Step S11), the portable terminal 50 transmits the login request to the MFP 10 and the model information (terminal information) of the self-device to the MFP 10 through the BLE communication (Step S12) (also see FIG. 9).

When the MFP 10 receives the login request and the model information from the portable terminal 50 (Step S21), the MFP 10 determines whether a requesting terminal (herein, the portable terminal 50) which transmits the login request has a biometric authentication function or not (Step S22).

Specifically, the MFP 10 determines whether the requesting terminal (portable terminal 50) of the login request has a biometric authentication function or not, on the basis of the terminal management table 300 (see FIG. 10) and the model information transmitted from the portable terminal 50 (Step S22). FIG. 10 is a view showing the terminal management table 300 (the terminal management information) for managing whether the biometric authentication function is provided or not, for each terminal model (each model of the portable terminal). Herein, as shown in FIG. 10, in the terminal management table 300, registered are information indicating that a “model M1” has a biometric authentication function and another information indicating that a “model M2” has no biometric authentication function. When it is determined that the requesting terminal of the login request has a biometric authentication function, on the basis of the model information transmitted from the portable terminal 50 and the terminal management table 300, the process goes to Step S23. On the other hand, it is determined that the requesting terminal has no biometric authentication function, on the basis of the model information transmitted from the portable terminal 50 and the terminal management table 300, the process goes to Step S30.

When the model information of “model M1” is transmitted from the requesting terminal of the login request, for example, on the basis of the model information of “model M1” and the terminal management table 300 (FIG. 10), it is determined that the requesting terminal has a biometric authentication function, and the process goes to Step S23. On the other hand, when the model information of “model M2” is transmitted from the requesting terminal of the login request, on the basis of the model information of “model M2” and the terminal management table 300, it is determined that the requesting terminal has no biometric authentication function, and the process goes to Step S30. Herein, the model information of “model M1” is received from the portable terminal 50, and it is determined that the requesting terminal of the login request (the portable terminal 50) has a biometric authentication function. Then, the process goes to Step S23. Further, an operation in the case where it is determined that the requesting terminal of the login request has no biometric authentication function (the process goes to Step S30) will be described later.

In Step S23, the MFP 10 transmits the transmission request of the terminal authentication information (herein, the user ID and the password) to be used for the terminal authentication and the biometric authentication request for requesting the execution of the biometric authentication by using the biometric authentication function of the portable terminal 50, to the portable terminal 50 through the BLE communication (also see FIG. 9). Further, when authentication information other than the user ID and the password (for example, a section ID, a section password, and the like) is also used in the terminal authentication, the transmission request of the terminal authentication information including the section ID and the section password is transmitted to the portable terminal 50.

When the portable terminal 50 receives the transmission request of the terminal authentication information and the biometric authentication request from the MFP 10 (Step S13), the portable terminal 50 performs the biometric authentication of the carrying user (operating user) (herein, user U1) of the portable terminal 50 by using the biometric authentication function thereof (in detail, the biometric authentication program) (Step S14) (also see FIG. 9). Herein, in the portable terminal 50, the fingerprint authentication is performed as the biometric authentication.

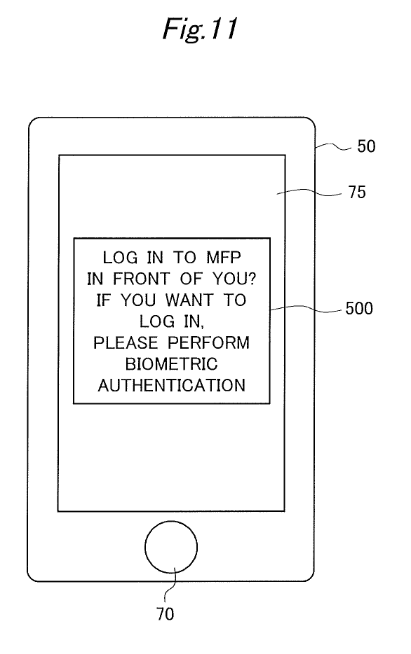

Specifically, the portable terminal 50 (biometric authentication control part 65) requests the carrying user (user U1) to place his finger on a placement position of the biometric authentication part 57 (herein, the button 70 around the touch panel 75). For example, as shown in FIG. 11, a message screen 500 showing a message of “Log in to MFP in front of you? If you want to log in, please perform biometric authentication” or the like is displayed on the touch panel 75 of the portable terminal 50.

When the user U1 places his finger on the button 70, the fingerprint of the finger is read (acquired) by the biometric authentication part 57 (fingerprint reader sensor). When the fingerprint of the finger is read, performed is the check (comparison) between the fingerprint information (biometric authentication information) read from the finger of the carrying user (user U1) and the fingerprint information (biometric authentication information of the authorized user) of the authorized user (user U1) of the portable terminal 50.

Thus, in the portable terminal 50, the biometric authentication (fingerprint authentication) is performed on the carrying user as the biometric authentication target person (Step S14). Then, it is determined whether the biometric authentication is successful or not (the success or failure of the biometric authentication is determined) in Step S15.

Specifically, when the biometric authentication information acquired from the carrying user coincides with the biometric authentication information of the authorized user on a predetermined level or more, it is determined that the biometric authentication is successful, and when the biometric authentication information acquired from the carrying user does not coincide with the biometric authentication information of the authorized user on the predetermined level, it is determined that the biometric authentication fails.

When it is determined in Step S15 that the biometric authentication is successful, the portable terminal 50 transmits the biometric authentication result indicating that the biometric authentication is successful and the terminal authentication information (the user ID and the password of the user U1) to the MFP 10 through the BLE communication (Step S16) (also see FIG. 9).

On the other hand, it is determined in Step S15 that the biometric authentication fails, the portable terminal 50 transmits the biometric authentication result indicating that the biometric authentication fails and the terminal authentication information to the MFP 10 (Step S18).

When the MFP 10 receives the terminal authentication information and the biometric authentication result from the portable terminal 50 (Step S24), the MFP 10 performs the terminal authentication by using the terminal authentication information transmitted from the portable terminal 50 (Step S25) (also see FIG. 9). Specifically, the MFP 10 (authentication part 14) checks (compares) the terminal authentication information transmitted from the portable terminal 50 against (with) the authorized terminal authentication information stored in the self-apparatus, to thereby perform the terminal authentication.

When there is the authorized terminal authentication information which coincides with the terminal authentication information received from the portable terminal 50, it is determined in Step S26 that the terminal authentication is successful, and the process goes to Step S27. On the other hand, when it is determined in Step S26 that the terminal authentication fails, the process goes to Step S29, and the MFP 10 rejects the login to the self-apparatus (Step S29).

In Step S27, it is determined whether the biometric authentication (herein, the fingerprint authentication) of the carrying user (user U1) of the portable terminal 50 is successful or not. Specifically, the MFP 10 (permission part 15) determines whether or not the biometric authentication result indicating that the biometric authentication of the carrying user of the portable terminal 50 is successful is received from the portable terminal 50. In other words, the MFP 10 (permission part 15) checks if the portable terminal 50 determines that the carrying user who currently has the portable terminal 50 which transmits the login request to the MFP 10 is a true authorized user (user U1) of the portable terminal 50.

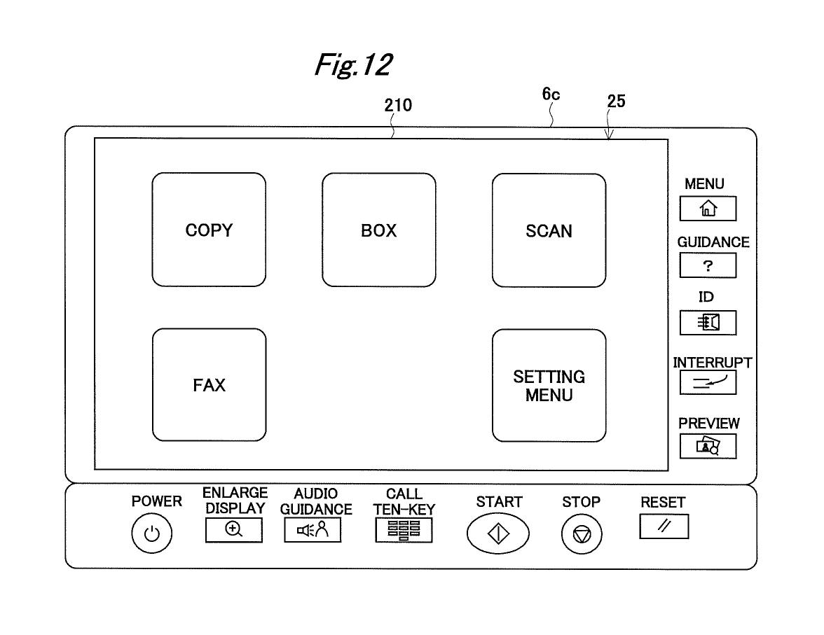

When the biometric authentication result indicating that the biometric authentication of the carrying user (user U1) of the portable terminal 50 is successful is received from the portable terminal 50, the process goes to Step S28, and the MFP 10 (permission part 15) permits the login to the self-apparatus by the carrying user (user U1) (also see FIG. 9). When the login is permitted, a menu screen 210 shown in FIG. 12 is displayed on the touch panel 25 of the MFP 10 and the user U1 can use the MFP 10.

On the other hand, it is determined in Step S27 that the biometric authentication result indicating that the biometric authentication of the carrying user of the portable terminal 50 fails is received from the portable terminal 50, the MFP 10 (permission part 15) rejects the login to the self-apparatus by the carrying user (Step S29). In other words, when the biometric authentication of the carrying user fails, even if the terminal authentication is successful, the login to the MFP 10 by the carrying user is rejected.

Thus, when the login to the MFP 10 is tried, the biometric authentication is also performed as well as the terminal authentication, and the login to the MFP 10 by the carrying user is permitted on the condition that the terminal authentication is successful and the biometric authentication of the carrying user of the portable terminal 50 (herein, the user U1) is also successful. In more detail, the login to the MFP 10 by the carrying user is permitted on the condition that the terminal authentication is successful in the MFP 10 and the biometric authentication result indicating that the biometric authentication of the carrying user of the portable terminal 50 is successful is received from the portable terminal 50.

Now, back to the determination process of Step S22, an operation in the case where it is determined that the requesting terminal of the login request has no biometric authentication function will be described.

Specifically, when it is determined that the requesting terminal of the login request has no biometric authentication function, the terminal authentication is performed and a “manual input authentication” (described next) is performed, instead of the biometric authentication. The “manual input authentication” (also referred to as a “basic authentication”) is an authentication process requiring a manual input (direct input) of the authentication information.

In more detail, when it is determined in Step S22 that the requesting terminal of the login request has no biometric authentication function, the MFP 10 transmits only the transmission request of the terminal authentication information to the portable terminal 50 (Step S30). In other words, the MFP 10 does not transmit the biometric authentication request to the requesting terminal which does not have any biometric authentication function.

In the portable terminal 50, only the transmission request of the terminal authentication information is received (the biometric authentication request is not received) and it is determined “NO” in Step S13. Then, the portable terminal 50 transmits only the terminal authentication information (the user ID and the password) to the MFP 10 (Step S17).

In the MFP 10, when the terminal authentication information is received from the portable terminal 50 (Step S31), the terminal authentication is performed on the basis of the terminal authentication information received from the portable terminal 50 and the authorized terminal authentication information stored in the MFP 10 (Step S32).

When, it is determined in Step S33 that the terminal authentication is successful, the MFP 10 (permission part 15) requests the carrying user (operating user) of the portable terminal 50 to perform a manual input (manual input operation) of the authentication information (manual input authentication information) used for the manual input authentication (Step S34).

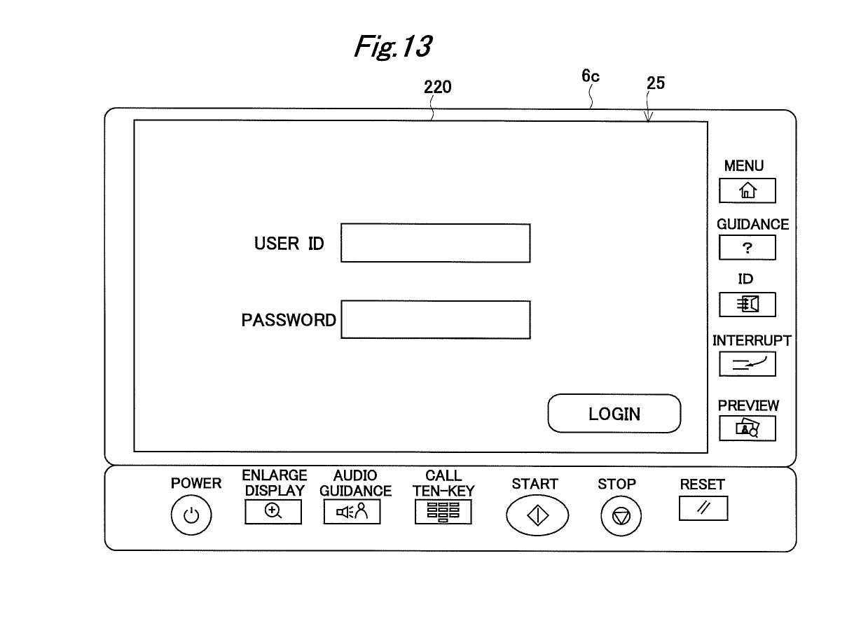

Specifically, the MFP 10 displays an input screen 220 shown in FIG. 13 on the touch panel 25, and requests the carrying user of the portable terminal 50 to perform the manual input of the manual input authentication information (herein, the same authentication information (the user ID and the password) as that used in the terminal authentication). Further, when the input screen 220 is already displayed on the touch panel 25 as a standby state before the login to the MFP 10, the manual input of the manual input authentication information may be requested by superimposedly displaying a message such as “Please input authentication information” on the input screen 220 (login screen).

Then, when the carrying user (operating user) of the portable terminal 50 inputs the manual input authentication information (the user ID and the password), the MFP 10 (authentication part 14) checks (compares) the manual input authentication information inputted by the carrying user against (with) the authorized manual input authentication information stored in the MFP 10, to thereby perform the manual input authentication (manual input authentication process).

When the manual input authentication is performed, it is determined in Step S35 whether the manual input authentication is successful or not. When the manual input authentication is successful, the login to the MFP 10 by the carrying user is permitted (Step S28). On the other hand, when the manual input authentication fails, the login is rejected (Step S36).

Thus, when the requesting terminal of the login request has no biometric authentication function, the biometric authentication is not performed in the portable terminal 50, and the manual input authentication is performed instead of the biometric authentication. Then, the login to the MFP 10 is permitted on the condition that the terminal authentication is successful and the manual input authentication is also successful.

As described above, in the operation of the first preferred embodiment, for the login to the MFP 10, the biometric authentication (Step S14) is performed as well as the terminal authentication (Step S25), and the login to the MFP 10 by the carrying user of the portable terminal 50 is permitted on the condition that the terminal authentication is successful and the biometric authentication is also successful (Steps S26, S27, and S28). In other words, the biometric authentication in which it is determined whether or not the carrying user is the real authorized user of the portable terminal 50 is performed as well as the terminal authentication, and the login to the MFP 10 is permitted only for the carrying user on whom both the authentications are successful. For this reason, even if a person other than the authorized user (user U1) intends to log in to the MFP 10 by stealing the portable terminal 50 of the user U1, when it is determined, by performing the biometric authentication, that the carrying user who currently has the portable terminal 50 is not the user U1, the login by the person different from the authorized user is not permitted. Therefore, even when a third party other than the authorized user (user U1) of the portable terminal 50 intends to log in to the MFP 10 by using (stealing) the portable terminal 50 of the user U1, it is possible to avoid the spoofing login to the MFP 10 by the third party.

Further, when the BLE communication or the like is used for the communication between the MFP 10 and the portable terminal 50, there is a possible case where when the carrying user (e.g., the user U1) of the portable terminal 50 only passes by the MFP 10, it is determined that the intensity of the BLE radio wave from the MFP 10 exceeds a certain level, and the terminal authentication is started in response to the proximity of the portable terminal 50 to the MFP 10. For this reason, when a conventional login process using only the terminal authentication is performed, there is a possibility that the login process may be (automatically) performed against the intention of the carrying user and the login may be permitted.

On the other hand, in the above-described first preferred embodiment, as described above, the biometric authentication is performed as well as the terminal authentication, and the login to the MFP 10 is permitted on the condition that both the authentications are successful. For this reason, when the carrying user of the portable terminal 50 does not perform any input operation in the biometric authentication (for example, the operation of placing the finger on the button 70 in the fingerprint authentication), the login to the MFP 10 is not permitted. Therefore, it is also possible to prevent the login to the MFP 10 from being permitted against the intention of the carrying user of the portable terminal 50.

Furthermore, in the above-described first preferred embodiment, in the biometric authentication performed in the portable terminal 50, the biometric authentication program preinstalled in the portable terminal 50 is used. For this reason, it is not necessary that a new biometric authentication program for the login to the MFP 10 should be additionally prepared and the new biometric authentication program should be downloaded in the portable terminal 50 in the login to the MFP 10, or the like. Therefore, it is possible to suppress an increase in the communication load between the MFP 10 and the portable terminal 50, an increase in the memory usage in the portable terminal 50, and the like, due to the download of the new biometric authentication program.

Further, though the exemplary case where the biometric authentication is performed in the portable terminal 50 has been described in the above-described first preferred embodiment, this is only one exemplary case, and the biometric authentication may be performed in the MFP 10 or the like, instead of the portable terminal 50. If the biometric authentication is performed in the MFP 10, however, such a problem as described below may be caused. Specifically, when the biometric authentication is performed in the MFP 10, for example, the MFP 10 registers therein the various pieces of biometric authentication information (e.g., the fingerprint information) of all the users who may use the biometric authentication, as the authorized biometric authentication information. For this reason, since various pieces of biometric authentication information as many as the users who may use the biometric authentication are stored in the MFP 10, there may arise a problem of increasing the memory usage in the MFP 10.

On the other hand, in the above-described first preferred embodiment, the biometric authentication is performed in the portable terminal 50 and the authentication result (biometric authentication result) is transmitted to the MFP 10. Then, in the MFP 10, on the basis of the biometric authentication result transmitted from the portable terminal 50, it is determined whether the biometric authentication performed in the portable terminal 50 is successful or not. For this reason, it is not necessary to store various pieces of biometric authentication information as many as all the users who may use the biometric authentication, as the authorized biometric authentication information, in the MFP 10 in advance, and therefore it is possible to suppress an increase in the memory usage in the MFP 10. Further, since the authentication result of the biometric authentication (a relatively small amount of data) is transmitted from the portable terminal 50 to the MFP 10, instead of the biometric authentication information (for example, the fingerprint information) itself (a relatively large amount of data) acquired from the carrying user, it is also possible to suppress an increase in the communication load between the MFP 10 and the portable terminal 50.

Furthermore, in the above-described first preferred embodiment, the exemplary case where the login process to the MFP 10 is performed by using at least two types of authentications, i.e., the terminal authentication and the biometric authentication has been described.

Herein, if the login process to the MFP 10 is performed by using only the biometric authentication (in other words, if the terminal authentication is not performed), even when the biometric authentication of the carrying user of the portable terminal 50 is successful, it is not determined whether or not the terminal authentication information (herein, the user ID and the password) of the carrying user has been already registered in the MFP 10. In other words, it is not determined whether the login request is a login request from a user (registered user) of the MFP 10 or not. For this reason, if the terminal authentication is not performed, there is a possibility that a login by a user other than the registered user of the MFP 10 may be permitted. Further, there is another possibility that the security may be reduced due to the login by a user other than the registered user of the MFP 10.

On the other hand, in the above-described first preferred embodiment, the terminal authentication is performed as the precondition, and in the terminal authentication, it is determined whether or not the terminal authentication information (the user ID and the password) of a requesting user of the login request has been already registered in the MFP 10. For this reason, it is possible to prevent a login by any user other than the registered users of the MFP 10 from being permitted.

Thus, in the present invention, by performing both the terminal authentication and the biometric authentication, it is possible to prevent the login by any user other than the registered users of the MFP 10 from being permitted and avoid a spoofing login to the MFP 10 by a third party other than the authorized user of the portable terminal 50. Further, by performing both the terminal authentication and the biometric authentication, it is possible to ensure higher security.

Furthermore, when the requesting terminal of the login request has no biometric authentication function, the manual input authentication (Step S34) is performed, instead of the biometric authentication. Then, the login to the MFP 10 is permitted on the condition that the terminal authentication is successful and the manual input authentication is also successful. In other words, the manual input authentication requiring the manual input of the authentication information is performed as well as the terminal authentication, and the login to the MFP 10 is permitted only for the carrying user on whom both the authentications are successful. So to speak, in the manual input authentication, by causing the carrying user (operating user) to manually input the authentication information (the user ID and the password) of the user who is a user of the MFP 10 and also an authorized user of the portable terminal 50, the MFP 10 determines (estimates) that the carrying user who currently has the portable terminal 50 is a true authorized user of the portable terminal 50. Therefore, even when a portable terminal which does not have any biometric authentication function is used, it is possible to avoid a spoofing login to the image forming apparatus by a third party other than an authorized user of the portable terminal.

Further, in the above-described first preferred embodiment, though the exemplary case has been described, where the biometric authentication result is transmitted from the portable terminal 50 to the MFP 10, regardless of whether the biometric authentication is successful or not, and the MFP 10 determines whether the biometric authentication performed in the portable terminal 50 is successful or not, on the basis of the biometric authentication result transmitted from the portable terminal 50, this is only one exemplary case. There may be another case, for example, where the biometric authentication result is transmitted from the portable terminal 50 to the MFP 10 only when the biometric authentication is successful and the MFP 10 determines whether the biometric authentication performed in the portable terminal 50 is successful or not, on the basis of whether or not the biometric authentication result is received from the portable terminal 50 after the biometric authentication request is transmitted.

Specifically, the MFP 10 transmits the biometric authentication request to the portable terminal 50 (Step S23), and the portable terminal 50 performs the biometric authentication in response to the biometric authentication request from the MFP 10 (Step S14).

When the biometric authentication performed in response to the biometric authentication request is successful, the portable terminal 50 transmits the biometric authentication result indicating that the biometric authentication is successful to the MFP 10 (Step S16), like in the above-described first preferred embodiment. Then, in the MFP 10, after the terminal authentication is successful, when it is determined that the biometric authentication is successful, on the basis of the biometric authentication result transmitted from the portable terminal 50, the process goes from Step S27 to Step S28, and the login to the MFP 10 by the carrying user of the portable terminal 50 is permitted.

On the other hand, when the biometric authentication performed in response to the biometric authentication request fails, the portable terminal 50 does not transmit the biometric authentication result indicating that the biometric authentication fails to the MFP 10 and transmits only the terminal authentication information to the MFP 10. Then, in the MFP 10, when the biometric authentication request is transmitted to the portable terminal 50 but the biometric authentication result is not received from the portable terminal 50 and only the terminal authentication information is received from the portable terminal 50, it is determined that the biometric authentication performed in the portable terminal 50 fails, and the process goes from Step S27 to Step S29 and the login is rejected. Further, when the biometric authentication result is not received from the portable terminal 50 until a predetermined time elapses since the biometric authentication request is transmitted, the MFP 10 may determine that the biometric authentication performed in the portable terminal 50 fails.

Thus, there may be a case where only when the biometric authentication is successful, the biometric authentication result is transmitted from the portable terminal 50 to the MFP 10, and it is determined whether the biometric authentication performed in the portable terminal 50 is successful or not, on the basis of whether or not the biometric authentication result is received from the portable terminal 50 after the biometric authentication request is transmitted.

### 2. The Second Preferred Embodiment

The second preferred embodiment is a variation of the first preferred embodiment. Hereinafter, description will be made, centering on the difference between the first and second preferred embodiments.

In the second preferred embodiment, setting (biometric authentication setting) on the biometric authentication to be performed in the portable terminal 50 is performed in the MFP 10 in advance for each user of the MFP 10, and the biometric authentication based on a setting content of the biometric authentication setting is performed in the portable terminal 50.

Specifically, in the MFP 10, an administrator sets (specifies) the type of biometric authentication to be performed in the portable terminal 50 and a set value (index value) on an authentication accuracy of the biometric authentication, in advance, for each user of the MFP 10. Then, in the portable terminal 50, the type of biometric authentication specified by the administrator is performed so that the set value on the authentication accuracy specified by the administrator can be achieved.

First, description will be made on the biometric authentication setting made by the administrator.

In the MFP 10, the administrator performs the setting on the biometric authentication (biometric authentication setting) for each user of the MFP 10. Herein, an exemplary case where the biometric authentication setting is performed for the user U1 who is one of the users of the MFP 10 and an authorized user of the portable terminal 50 will be described.

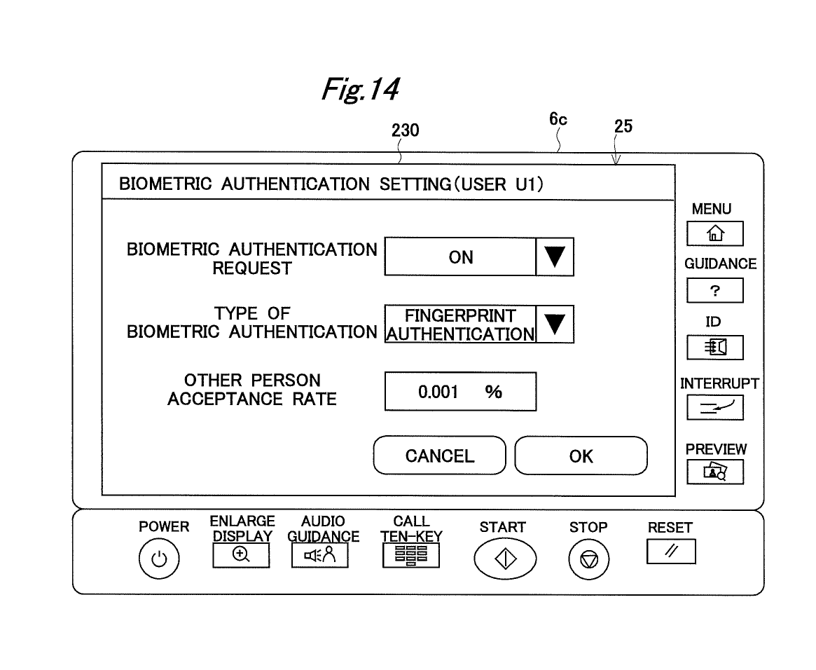

FIG. 14 is a view showing a biometric authentication setting screen 230 used for performing the biometric authentication setting for the user U1. The biometric authentication setting screen 230 is displayed on the touch panel 25 of the MFP 10. Herein, in the biometric authentication setting screen 230, the administrator sets three setting items, i.e., “biometric authentication request”, “type of biometric authentication”, and “other person acceptance rate”, for the user U1.

First, the administrator sets the setting item of “biometric authentication request” (the necessity/unnecessity of the biometric authentication) for the user U1.

When the administrator determines that the biometric authentication is needed for the user U1, for example, the administrator sets “ON” to the setting item of “biometric authentication request” in the biometric authentication setting screen 230. When “ON” is set to the setting item of “biometric authentication request” (when it is set that the biometric authentication is needed for the user U1), as described later, the biometric authentication request is transmitted to the portable terminal 50 of the user U1 in response to the login request from the portable terminal 50 of the user U1. On the other hand, when the administrator determines that the biometric authentication is not needed for the user U1, the administrator sets “OFF” to the setting item of “biometric authentication request” in the biometric authentication setting screen 230. When “OFF” is set to the setting item of “biometric authentication request” (when it is set that the biometric authentication is not needed for the user U1), the biometric authentication request is not transmitted to the portable terminal 50 of the user U1. Herein, as shown in FIG. 14, for the user U1, “ON” is set to the setting item of “biometric authentication request” (it is set that the biometric authentication is needed).

Next, the administrator sets the setting item of “type of biometric authentication” for the user U1.

Specifically, the administrator specifies (sets) the type of biometric authentication to be performed in the portable terminal 50 of the user U1, among a plurality of types of biometric authentications (for example, fingerprint authentication, iris authentication, face authentication, and the like). Herein, as shown in FIG. 14, the “fingerprint authentication” is set (specified) as the type of biometric authentication to be performed in the portable terminal 50 of the user U1, among the plurality of types of biometric authentications.

Further, the administrator sets (specifies) the setting item of “other person acceptance rate” for the user U1.

The “other person acceptance rate” refers to the probability of falsely recognizing any other person as someone himself (herein, the true authorized user of the portable terminal 50). Herein, the “other person acceptance rate” is used as an index indicating the authentication accuracy in the biometric authentication. In the portable terminal 50, the biometric authentication is performed by changing (adjusting) threshold values or the like of various parameters used for the biometric authentication, so that the set other person acceptance rate (the set value on the authentication accuracy) can be achieved. When the other person acceptance rate is set to a relatively small value, for example, the biometric authentication is performed by changing (adjusting) the threshold value on the degree of similarity or the like between the biometric authentication information acquired from the authentication target person and the authorized biometric authentication information to a value (for example, a relatively large value) with which the set other person acceptance rate can be achieved. In contrast, when the other person acceptance rate is set to a relatively large value, the biometric authentication is performed by changing the threshold value on the degree of similarity or the like to a value (for example, a relatively small value) with which the set other person acceptance rate can be achieved. By setting the set value of the other person acceptance rate to a relatively small value, the administrator makes it possible to perform the biometric authentication with a relatively high authentication accuracy (to reduce the probability of falsely recognizing any other person as someone himself (herein, the user U1). Herein, as shown in FIG. 14, the administrator sets (inputs) a value of “0.001”% to the “other person acceptance rate” (in detail, the allowable upper limit value thereof).

Further, though the exemplary case where the “other person acceptance rate” is used as the index indicating the authentication accuracy in the biometric authentication has been described herein, this is only one exemplary case and, for example, a “false rejection rate (the probability of falsely recognizing someone (the authorized user) as any other person)” or the like may be used as the index indicating the authentication accuracy in the biometric authentication. Alternatively, as the index indicating the authentication accuracy in the biometric authentication, both the “other person acceptance rate” and the “false rejection rate” may be used.

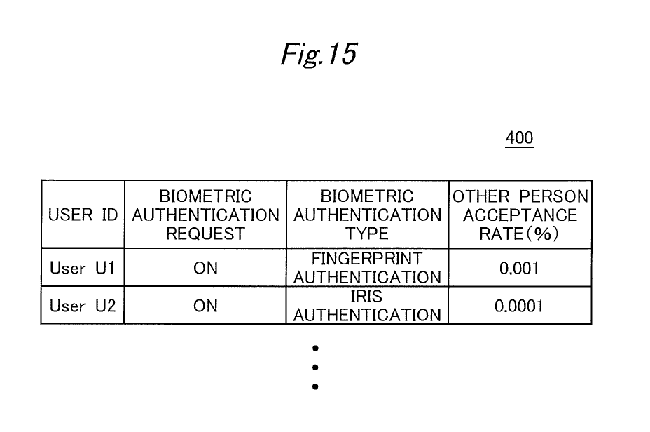

When the biometric authentication setting for user U1 is performed, the respective setting contents of the setting items are associated with user specifying information (herein, the user ID) and registered in the storage part 5 (in detail, a biometric authentication setting management table 400 (see FIG. 15)) in the MFP 10.

Specifically, in the biometric authentication setting management table 400, the necessity/unnecessity of the biometric authentication for a specific user among the users of the MFP 10 is associated with the user ID of the specific user and registered therein. As shown in FIG. 15, for example, the necessity of the biometric authentication (the necessity of transmitting the biometric authentication request) for the user U1 is associated with the user ID (“User U1”) of the user U1 and registered in the biometric authentication setting management table 400.

Further, in the biometric authentication setting management table 400, the type of biometric authentication to be performed in the portable terminal of the specific user, among the plurality of types of biometric authentications, is also associated with the user ID of the specific user and registered therein. As shown in FIG. 15, for example, the type of biometric authentication (herein, the fingerprint authentication) specified for the user U1 by the administrator, among the plurality of types of biometric authentications, is associated with the user ID (“User U1”) of the user U1 and registered in the biometric authentication setting management table 400.

Furthermore, in the biometric authentication setting management table 400, the set value of the other person acceptance rate (the set value on the authentication accuracy) in the biometric authentication to be performed in the portable terminal of the specific user is associated with the user ID of the specific user and registered therein. As shown in FIG. 15, for example, the set value of the other person acceptance rate, “0.001”%, specified (set) for the user U1 by the administrator is associated with the user ID (“User U1”) of the user U1 and registered in the biometric authentication setting management table 400.

Thus, the administrator performs the biometric authentication setting for the user U1 in advance, and the setting contents of the biometric authentication setting for the user U1 is associated with the user ID of the user U1 and registered. Similarly, the administrator also performs the biometric authentication setting for another user (a user of the MFP 10 other than the user U1) in advance. Further, the setting contents in the biometric authentication setting may be associated with identifying information (e.g., a MAC address) of the portable terminal of the user of the MFP 10, instead of the user specifying information (the user ID) of the user of the MFP 10, and registered.

Next, description will be made on an operation of the MFP 10 and an operation of the portable terminal 50 after the biometric authentication setting is performed by the administrator.

After Step S11 (FIG. 7), in Step S12, the portable terminal 50 transmits the user specifying information to the MFP 10, as well as the login request and the model information. Herein, as the user specifying information, the user ID (the user ID, “User U1”, of the user U1 who is the authorized user of the portable terminal 50) is transmitted from the portable terminal 50 to the MFP 10.

In the MFP 10, after Steps S21 and S22 and before Step S23, the necessity/unnecessity of the biometric authentication for the user U1 (the user who is one of the users of the MFP 10 and the authorized user of the portable terminal 50) is determined on the basis of the biometric authentication setting management table 400 (FIG. 15).

Specifically, the MFP 10 determines whether or not the necessity of the biometric authentication for the user U1 is set, on the basis of the biometric authentication setting management table 400 and the user specifying information (herein, the user ID) transmitted from the portable terminal 50. When the necessity of the biometric authentication for the user U1 is set, the process goes to Step S23, and when the unnecessity of the biometric authentication for the user U1 is set, the process goes to Step S30. Herein, since the necessity of the biometric authentication for the user U1 is set (see FIG. 15), the process goes to Step S23. Further, an operation in the case where the unnecessity of the biometric authentication is set for the user who is one of the users of the MFP 10 and the authorized user of the portable terminal 50 will be described later.

In Step S23, the information on the setting contents (in detail, the type of biometric authentication and the other person acceptance rate) for the specific user (the authorized user U1 of the portable terminal 50) among a plurality of users of the MFP 10 is transmitted to the portable terminal 50, together with the transmission request of the terminal authentication information and the biometric authentication request.

Specifically, first, the MFP 10 refers to (checks) the biometric authentication setting management table 400 (FIG. 15) and specifies the setting contents (the type of biometric authentication and the other person acceptance rate) corresponding to the user U1 among the users of the MFP 10. In more detail, the MFP 10 specifies the fingerprint authentication among the plurality of types of biometric authentications, as the type of biometric authentication to be performed in the portable terminal 50 of the user U1, on the basis of the user ID (“User U1”) of the user U1. Further, the MFP 10 also specifies the set value (the set value (allowable upper limit value) of the other person acceptance rate), “0.001”%, on the authentication accuracy in the biometric authentication to be performed in the portable terminal 50 of the user U1, on the basis of the user ID (“User U1”) of the user U1.

Then, in Step S23, the MFP 10 transmits the biometric authentication type information (biometric authentication type specifying information) indicating that a specific type of biometric authentication (the type of biometric authentication set for the user U1 (herein, the fingerprint authentication)) among the plurality of types of biometric authentications should be performed, as well as the transmission request of the terminal authentication information and the biometric authentication request, to the portable terminal 50. Further, in Step S23, the MFP 10 also transmits the authentication accuracy information (authentication accuracy specifying information) specifying the set value (the set value of the other person acceptance rate (herein, a value of “0.001”%)) set for the user U1, as a predetermined set value (the set value of the other person acceptance rate) on the authentication accuracy in the biometric authentication, to the portable terminal 50.

Thus, the MFP 10 transmits the biometric authentication type information and the authentication accuracy information corresponding to the user U1 to the portable terminal 50, on the basis of the biometric authentication setting management table 400 and the user ID (“User U1”) transmitted from the portable terminal 50.

In the portable terminal 50, when the biometric authentication type information and the authentication accuracy information are also received as well as the transmission request of the terminal authentication information and the biometric authentication request (Step S13), the biometric authentication is performed on the basis of the biometric authentication type information and the authentication accuracy information (Step S14).

Specifically, in Step S14, the portable terminal 50 (biometric authentication control part 65) performs the type of biometric authentication (herein, the fingerprint authentication) specified (set) for the user U1 by the administrator among the plurality of types of biometric authentications, on the basis of the biometric authentication type information. Further, when the portable terminal 50 (the biometric authentication program) cannot perform (does not have any function of performing) the type of biometric authentication (fingerprint authentication) specified by the administrator, the portable terminal 50 transmits the biometric authentication result indicating that the biometric authentication fails, to the MFP 10.

Furthermore, in Step S14, the portable terminal 50 (biometric authentication control part 65) performs the biometric authentication (herein, the fingerprint authentication) so that the other person acceptance rate may fall in the range not higher than the set value of “0.001”%, which is set (specified) for the user U1. Specifically, the portable terminal 50 (biometric authentication control part 65) performs the biometric authentication (fingerprint authentication) by changing (adjusting) the threshold values of various parameters (e.g., the degree of similarity) in the biometric authentication so that the other person acceptance rate not higher than the set value of “0.001”% can be achieved.

Further, the processes (processes of Steps S15, S16, S18, and S24 to S29) after the biometric authentication is performed are the same as those in the first preferred embodiment.

Now, in the MFP 10, after Step S22 of FIG. 8, when the unnecessity of the biometric authentication is set for the specific user who is one of the users of the MFP 10 and the authorized user of the portable terminal 50, the biometric authentication request is not transmitted to the portable terminal 50 and the process goes to Step S30. Then, in the MFP 10, the terminal authentication and the manual input authentication are performed.

Specifically, when the unnecessity of the biometric authentication is set for the specific user, only the transmission request of the terminal authentication information is transmitted from the MFP 10 to the portable terminal 50 (Step S30), and the portable terminal 50 transmits the terminal authentication information stored in the self-device to the MFP 10 in response to the transmission request (Step S17). The MFP 10 performs the terminal authentication based on the terminal authentication information transmitted from the portable terminal 50 and the authorized terminal authentication information (Step S32), and when the terminal authentication is successful, the MFP 10 requests the carrying user of the portable terminal 50 to manually input the manual input authentication information (Step S34). Then, when it is determined that the manual input authentication based on the manual input authentication information inputted by the carrying user and the authorized manual input authentication information is successful (Step S35), the login to the MFP 10 is permitted (Step S28).

Thus, when the unnecessity of the biometric authentication is set for the specific user, the login to the MFP 10 is permitted on the condition that the terminal authentication is successful and the manual input authentication is also successful.

Herein, if the administrator cannot specify the type of biometric authentication to be performed in the portable terminal 50, such a problem as described below may be caused. When the face authentication is performed in the portable terminal 50, for example, since the authentication accuracy of the face authentication is relatively lower than the authentication accuracy of the fingerprint authentication, though the carrying user of the portable terminal 50 is a person different from the authorized user (user U1), there may arise a problem that the possibility of falsely recognizing the person as the true user U1 is relatively high.

On the other hand, in the second preferred embodiment, the administrator sets (specifies) the type of biometric authentication to be performed in the portable terminal 50, among the plurality of types of biometric authentications, in advance, and the portable terminal 50 performs the type of biometric authentication, which is specified by the administrator. For this reason, by specifying the type of biometric authentication (for example, the fingerprint authentication) which ensures a relatively high authentication accuracy, the administrator can cause the portable terminal 50 to perform the type of biometric authentication which makes it hard to invite a spoofing login by any person other than the authorized user.

Further, the administrator sets (specifies) the set value on the authentication accuracy in the biometric authentication (herein, the set value of the other person acceptance rate) in advance, and the portable terminal 50 performs the biometric authentication by changing (adjusting) various parameters used for the biometric authentication, so that the authentication accuracy of the set value (the set value of the other person acceptance rate) specified by the administrator can be achieved. For this reason, the administrator can cause the biometric authentication to be performed with a desired authentication accuracy (a desired other person acceptance rate).

Furthermore, in the above-described second preferred embodiment, though the exemplary case where the type of biometric authentication to be performed and the set value on the authentication accuracy (the set value of the other person acceptance rate) are set for each user of the MFP 10 has been described, this is only one exemplary case and the type of biometric authentication and the set value may be set uniformly for all the users of the MFP 10.

For example, the administrator sets the type of biometric authentication (e.g., the fingerprint authentication) to be performed in the portable terminal and the set value of the other person acceptance rate (e.g., a value of “0.001”%) in advance on a biometric authentication setting screen common to all the users of the MFP 10.

Then, when the login request is received from the portable terminal 50 of the user U1, for example, the biometric authentication type information indicating that a specific type of biometric authentication (fingerprint authentication) among the plurality of types of biometric authentications should be performed is transmitted to the portable terminal 50 (Step S23). Further, in Step S23, the authentication accuracy information specifying the set value (the other person acceptance rate (“0.001”%)) on the authentication accuracy is also transmitted to the portable terminal 50.

In the portable terminal 50 of the user U1, the fingerprint authentication is performed so that the other person acceptance rate not higher than the set value of “0.001”% can be achieved, on the basis of the biometric authentication type information and the authentication accuracy information (Step S14).

Further, also when a login request is received from a portable terminal of a user U2 who is one of the users of the MFP 10 and different from the user U1, similarly, the MFP 10 causes the portable terminal of the user U2 to perform the fingerprint authentication so that the other person acceptance rate not higher than the set value of “0.001”% can be achieved.

Thus, the type of biometric authentication to be performed and the set value on the authentication accuracy may be set (specified) uniformly for all the users of the MFP 10. With such a setting, the administrator can standardize the type of biometric authentication to be performed in the portable terminals of all the users of the MFP 10 and the authentication accuracy in the biometric authentication to be performed.

This variation is not limited to the above exemplary case where both the type of biometric authentication and the set value are set uniformly for all the users of the MFP 10, either one of the type of biometric authentication and the set value may be set uniformly for all the users of the MFP 10.

Further, in the above-described second preferred embodiment, though the exemplary case where the biometric authentication setting (the setting on the type of biometric authentication and the set value on the authentication accuracy) is performed by the administrator in the MFP 10 has been described, this is only one exemplary case. For example, the biometric authentication setting may be performed in an apparatus (e.g., a personal computer of the administrator) different from the MFP 10. When the biometric authentication setting is performed in the different apparatus, the setting contents of the biometric authentication setting which are set by the administrator are transmitted to the MFP 10 and registered in the biometric authentication setting management table 400 (FIG. 15) inside the MFP 10.

### 3. The Third Preferred Embodiment

The third preferred embodiment is a variation of the first preferred embodiment. Hereinafter, description will be made, centering on the difference between the first and third preferred embodiments.

In the above-described first preferred embodiment, the exemplary case where the processes shown in FIG. 8 (the process of performing the terminal authentication, the process of determining whether to permit the login to the MFP 10, and the like) are performed by the MFP 10 has been described.

In the third preferred embodiment, described will be an exemplary case where the processes shown in FIG. 8 (the process of performing the terminal authentication, the process of determining whether to permit the login to the MFP 10, and the like) are performed by an external server 80.

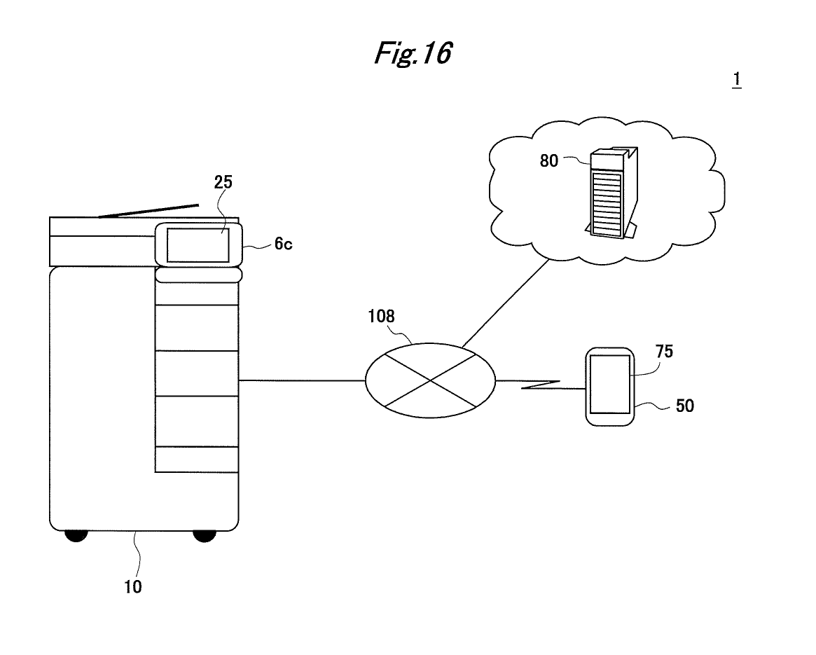

FIG. 16 is a view showing a communication system (authentication system) 1 in accordance with the third preferred embodiment. As shown in FIG. 16, the communication system 1 of the third preferred embodiment comprises the MFP 10, the portable terminal 50, and the external server 80.

The external server 80 is an external device which is provided separately from the MFP 10 and the portable terminal 50. The external server 80 is a server device comprising an authentication function on the terminal authentication (the terminal authentication function), and also referred to as an authentication server.

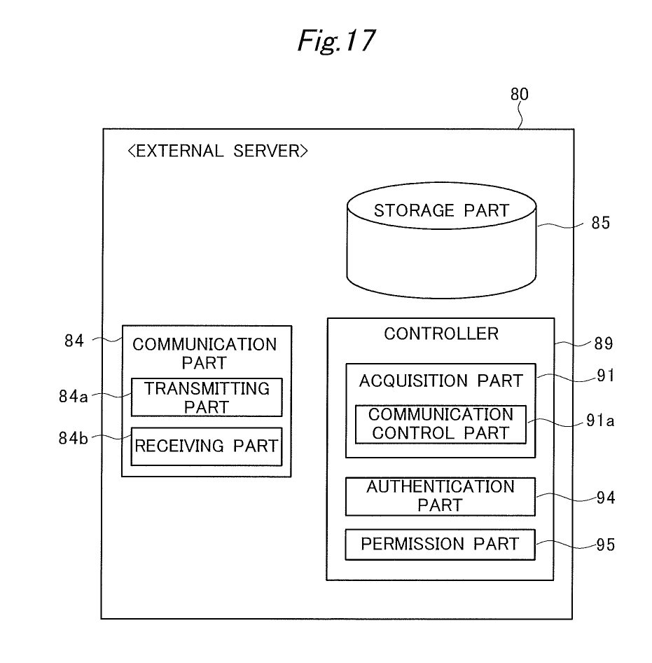

FIG. 17 is a view showing functional blocks of the external server 80. As shown in FIG. 17, the external server 80 comprises a communication part 84, a storage part 85, a controller (control part) 89, and the like and multiply uses these constituent parts to implement various functions.

The communication part 84 is capable of transmitting and receiving various data to/from desired partners (the MFP 10 and the like) by using the network communication via a network 108. The communication part 84 has a transmitting part 84a for transmitting various data and a receiving part 84b for receiving various data.

The storage part 85 is a storage unit such as a hard disk drive (HDD) or/and the like. For example, the storage part 85 stores therein the authorized terminal authentication information (herein, the user ID and the password). Further, the storage part 85 also stores therein the terminal management table 300 (see FIG. 10).

The controller (control part) 89 is a control unit for generally controlling the external server 80. The controller 89 is a computer system which is embedded in the external server 80 and comprises a CPU, various semiconductor memories (RAM and ROM), and the like. The controller 89 causes the CPU to execute a predetermined software program (hereinafter, also referred to simply as a program) stored in the ROM (e.g., EEPROM (registered trademark)), to thereby implement various processing parts. Further, the program (in more detail, a group of program modules) may be recorded in one of various portable recording media (in other words, various non-transitory computer-readable recording media), such as a USB memory or the like, and read out from the recording medium to be installed in the external server 80. Alternatively, the program may be downloaded via the wireless LAN or the like to be installed in the external server 80.

Specifically, as shown in FIG. 17, the controller 89 executes the above-described program, to thereby implement various processing parts including an acquisition part 91, an authentication part 94, and a permission part 95.

The acquisition part 91 is a processing part for controlling an operation of acquiring various information, or the like. For example, the acquisition part 91 acquires the authentication result of the terminal authentication performed in the external server 80, and also acquires the authentication result of the biometric authentication performed in the portable terminal 50 by using a communication control part 91a. The acquisition part 91 has the communication control part 91a. The communication control part 91a is a processing part for controlling a communication with other apparatus(es) (the MFP 10 or/and the like) in cooperation with the communication part 84 and the like.

The authentication part 84 and the permission part 95 in the external server 80 are processing parts for controlling the same operations and the like as those of the authentication part 14 and the permission part 15 (see the above-described first preferred embodiment) in the MFP 10.

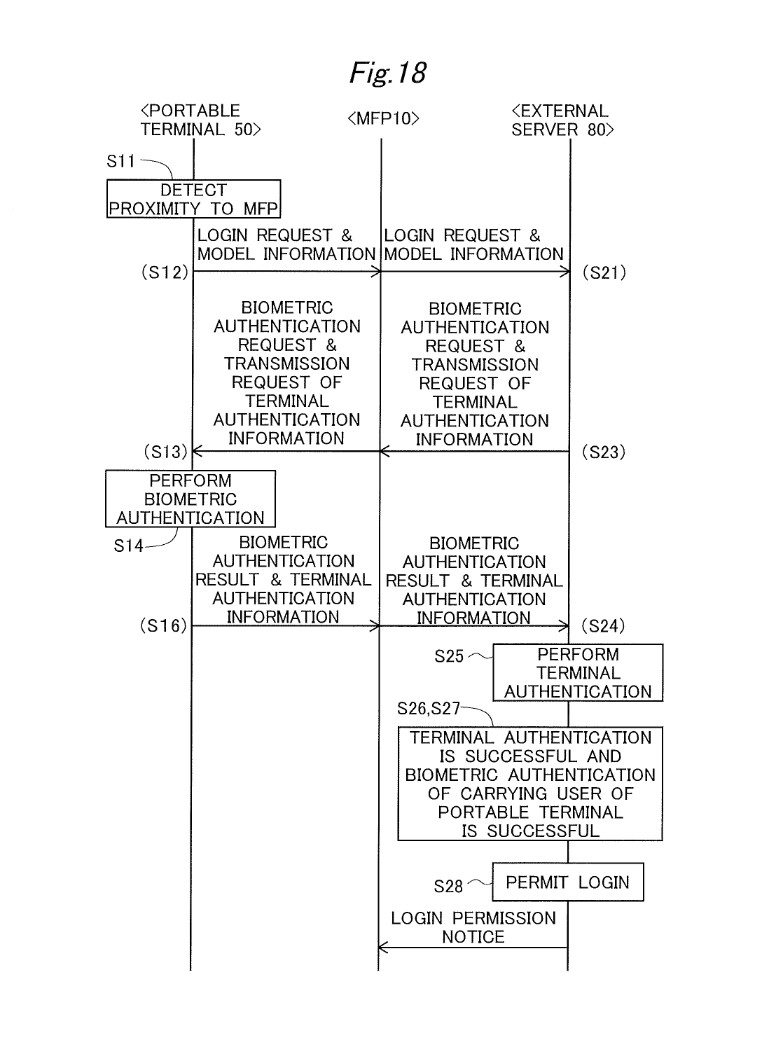

With reference to FIGS. 7, 8, and 18, an exemplary case where the same operations as those of the MFP 10 in the first preferred embodiment are performed in the external server 80 will be described. FIG. 18 is a timing chart showing an exemplary operation of the communication system 1 in accordance with the third preferred embodiment.

Further, in the communication system 1 of the third preferred embodiment, the MFP 10 operates as a relay apparatus for relaying various types of information between the portable terminal 50 and the external server 80. Various types of information from the portable terminal 50 are transmitted to the external server 80 through the MFP 10, and various types of information from the external server 80 are transmitted to the portable terminal 50 through the MFP 10. For the communication between the MFP 10 and the portable terminal 50, the BLE communication is used like in the first preferred embodiment, and for the communication between the MFP 10 and the external server 80, the wireless (or wired) communication via the network 108 is used.

Specifically, when the proximity to the MFP 10 is detected (Step S11), the login request and the model information are transmitted from the portable terminal 50 to the external server 80 through the MFP 10 (Steps S12 and S21) (also see FIG. 18).

Then, when it is determined that the requesting terminal (portable terminal 50) of the login request has a biometric authentication function (Step S22), the external server 80 transmits the transmission request of the terminal authentication information and the biometric authentication request to the portable terminal 50 through the MFP 10 (Steps S23 and S13).

In response to the biometric authentication request transmitted from the external server 80, the portable terminal 50 performs the biometric authentication of the carrying user of the portable terminal 50 (Step S14), and when the biometric authentication is successful, the portable terminal 50 transmits the biometric authentication result indicating that the biometric authentication is successful and the terminal authentication information to the external server 80 through the MFP 10 (Steps S16 and S24).

Then, in the external server 80, the terminal authentication based on the terminal authentication information transmitted from the portable terminal 50 and the authorized terminal authentication information stored in the self-device is performed (Step S25) and the terminal authentication result is acquired.

Further, the external server 80 determines whether to permit the login to the image forming apparatus by the carrying user of the portable terminal 50, on the basis of the authentication result of the terminal authentication and the authentication result of the biometric authentication, and transmits a notice on the determination result (login permission/rejection notice) to the MFP 10.

When it is determined in Step S26 that the terminal authentication performed in the external server 80 is successful and it is determined in Step S27 that the biometric authentication performed in the portable terminal 50 is successful, for example, the external server 80 permits the login to the MFP 10 by the carrying user of the portable terminal 50 (Step S28). When the login to the MFP 10 is permitted, the external server 80 transmits, to the MFP 10, a notice (login permission notice) indicating that the login by the carrying user of the portable terminal 50 is permitted (also see FIG. 18). Then, the MFP 10 displays the menu screen 210 (FIG. 12) on the touch panel 25, on the basis of the login permission notice.

On the other hand, when the terminal authentication performed in the external server 80 fails or when the biometric authentication performed in the portable terminal 50 fails, the external server 80 rejects the login to the MFP 10 by the carrying user of the portable terminal 50 (Step S29). When the login to the MFP 10 is rejected, the external server 80 transmits, to the MFP 10, a notice (login rejection (non-permission) notice) indicating that the login by the carrying user of the portable terminal 50 is rejected. Then, the MFP 10 rejects the login to the self-apparatus by the carrying user, on the basis of the login non-permission notice.

Further, also when it is determined in Step S22 that the requesting terminal of the login request has no biometric authentication function and the process goes to Step S30, the same operations as those of the MFP 10 from Step S30 in the first preferred embodiment are performed in the external server 80. The input operation (manual input operation) in the manual input authentication, however, is performed by the carrying user of the portable terminal 50 on the touch panel 25 of the MFP 10 and the manual input authentication information inputted by the carrying user is transmitted from the MFP 10 to the external server 80.

Thus, the same operations as those of the MFP 10 in the first preferred embodiment are performed in the external server 80.

Further, in the above-described third preferred embodiment, though the exemplary case where the same operations as all the operations of the MFP 10 in the first preferred embodiment are performed in the external server 80 has been described, this is only one exemplary case and the same operations as some of the operations of the MFP 10 in the first preferred embodiment may be performed in the external server 80. There may be another case, for example, where the processes other than the process for the manual input authentication (Steps S34 and S35), among all the operations (the processes in FIG. 8) of the MFP 10 in the first preferred embodiment, are performed in the external server 80 and the process for the manual input authentication is performed in the MFP 10 like in the first preferred embodiment.

Furthermore, in the above-described third preferred embodiment, though the exemplary case where all the information (the terminal authentication information and the like) which are transmitted and received between the portable terminal 50 and the external server 80 are transmitted through the MFP 10 (by using the MFP 10 as a relay) to the destination device (the external server 80 or the portable terminal 50) has been described, this is only one exemplary case. For example, all the information or some of the information which are transmitted and received between the portable terminal 50 and the external server 80 may be transmitted from the external server 80 directly to the portable terminal 50, or from the portable terminal 50 directly to the external server 80, not through the MFP 10.

Further, in the above-described third preferred embodiment, though the exemplary case where the same operations as those of the MFP 10 in the first preferred embodiment are performed in the external server 80 has been described, this is only one exemplary case. For example, the same operations as those of the MFP 10 in any other preferred embodiment (the second preferred embodiment) or the like may be performed in the external server 80. When the same operations as those of the MFP 10 in the second preferred embodiment are performed in the external server 80, the setting operations in the biometric authentication setting (the settings on the necessity/unnecessity of the biometric authentication, the type of biometric authentication, and the set value on the authentication accuracy) by the administrator may be performed by using an administrator's computer or the like. However, this is only one exemplary case and the setting operations may be performed in the MFP 10.

### 4. The Fourth Preferred Embodiment

The fourth preferred embodiment is a variation of the first preferred embodiment. Hereinafter, description will be made, centering on the difference between the first and fourth preferred embodiments.

In the above-described first preferred embodiment, the exemplary case where after the biometric authentication is performed in the portable terminal 50, the biometric authentication result and the terminal authentication information are transmitted from the portable terminal 50 to the MFP 10 at the same time and the terminal authentication based on the terminal authentication information is performed in the MFP 10 has been described. Specifically, in the above-described first preferred embodiment, as shown FIG. 9 and the like, the exemplary case where the biometric authentication is first performed (Step S14) and then the terminal authentication is performed (Step S25) has been described.

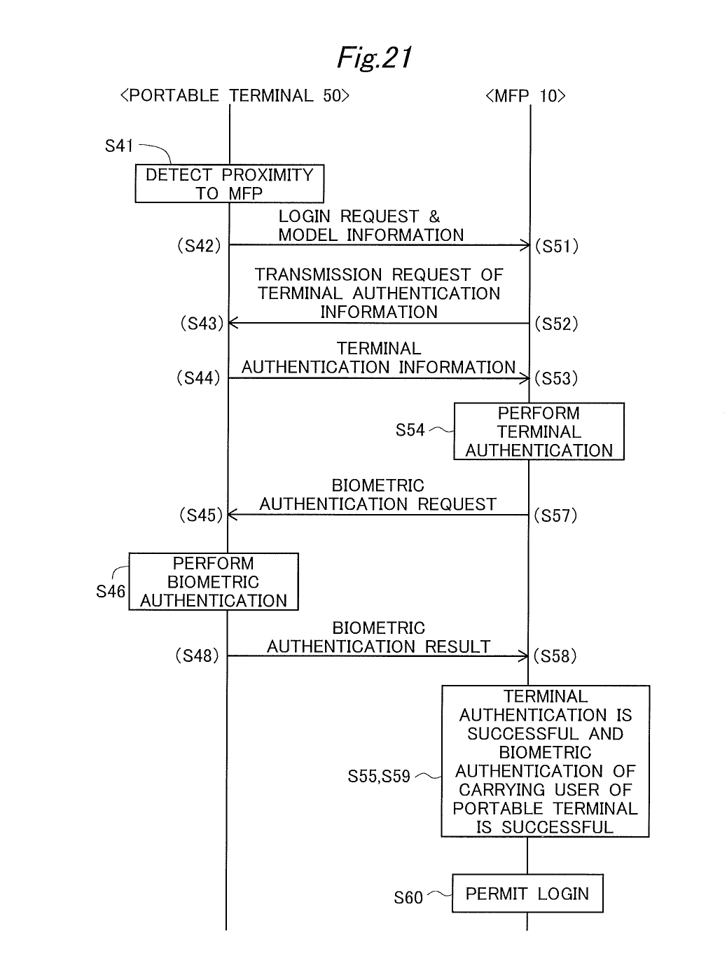

In the fourth preferred embodiment, conversely, as shown in FIG. 21 and the like, the exemplary case where the terminal authentication is first performed (Step S54) and then the biometric authentication is performed (Step S46) will be described.

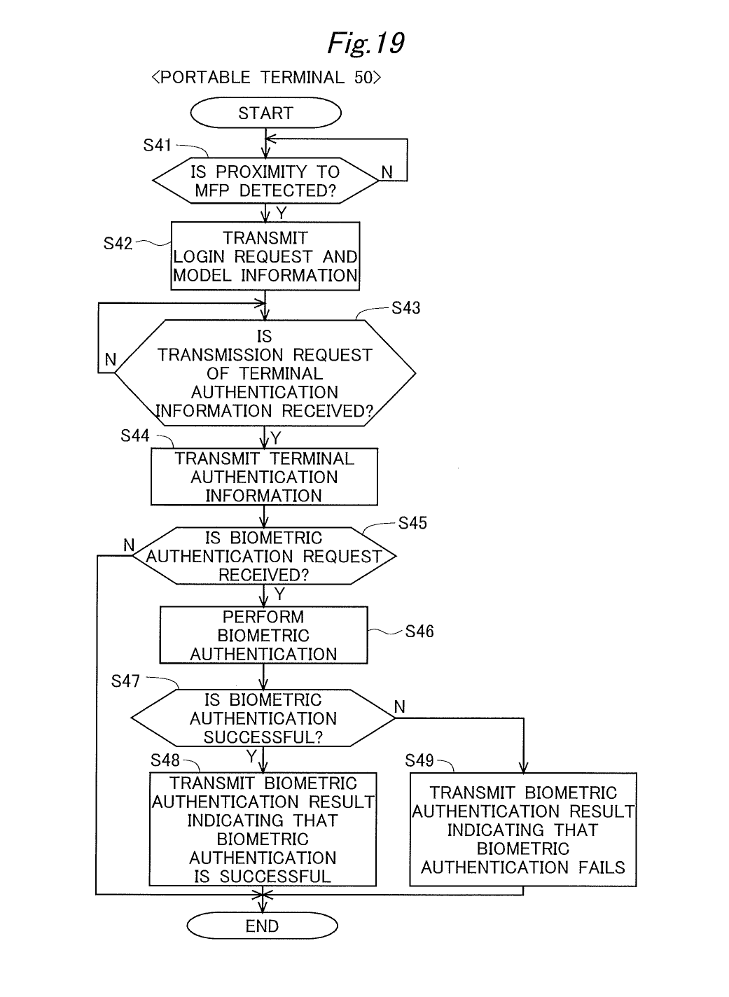

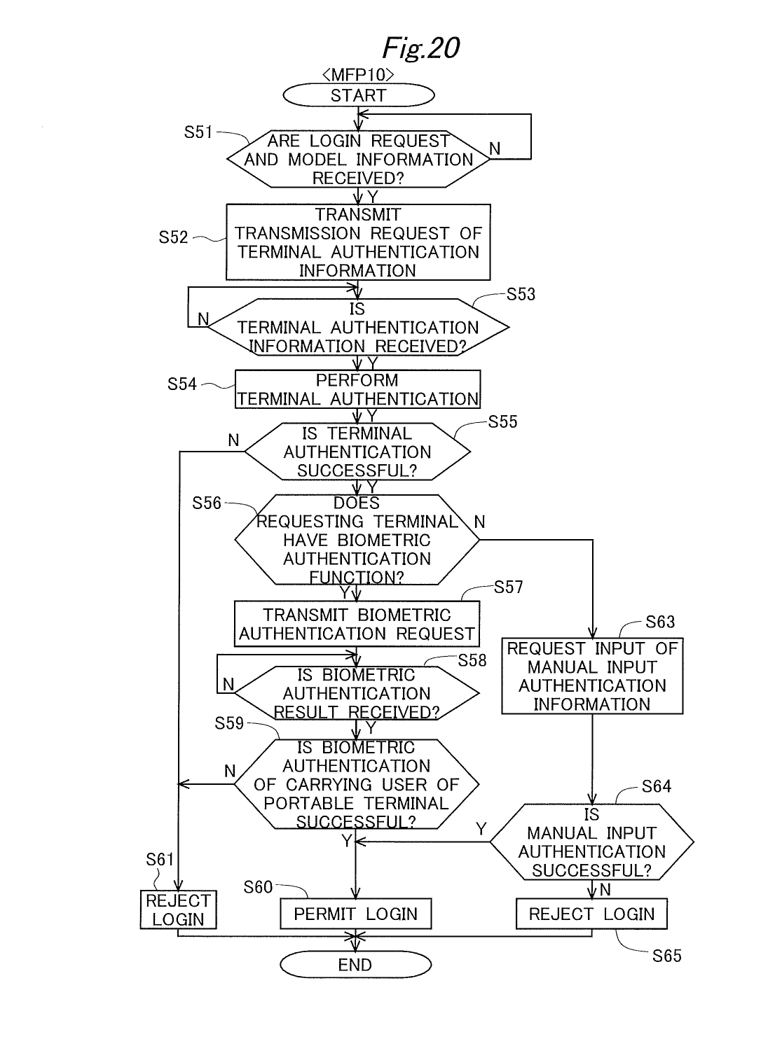

FIG. 19 is a flowchart showing an operation of the portable terminal 50 in accordance with the fourth preferred embodiment, and FIG. 20 is a flowchart showing an operation of the MFP 10 in accordance with the fourth preferred embodiment. Further, FIG. 21 is a timing chart showing an exemplary operation of the communication system 1 in accordance with the fourth preferred embodiment. With reference to FIGS. 19 to 21, description will be made.

The processes of Steps S41 and S42 in FIG. 19 are the same as those of Steps S11 and S12 in FIG. 7, and the process of Step S51 in FIG. 20 is the same as that of Step S21 in FIG. 8 (see the first preferred embodiment). Specifically, when the proximity of the portable terminal 50 to the MFP 10 is detected (Step S41), the login request and the model information are transmitted from the portable terminal 50 to the MFP 10 (Steps S42 and S51) (also see FIG. 21).

In Step S52, the MFP 10 transmits only the transmission request of the terminal authentication information (the user ID and the password) to the portable terminal 50. Thus, in the fourth preferred embodiment, first, only the transmission request of the terminal authentication information is transmitted to the portable terminal 50. As described later, the biometric authentication request is transmitted from the MFP 10 to the portable terminal 50 (Step S57 described later) after the terminal authentication is performed in the MFP 10.

When the transmission request of the terminal authentication information is received from the MFP 10 (Step S43), the portable terminal 50 transmits the terminal authentication information stored in the self-device to the MFP 10 in response to the transmission request (Step S44) (also see FIG. 21).

When the terminal authentication information is received from the portable terminal 50 (Step S53), the MFP 10 performs the terminal authentication based on the terminal authentication information transmitted from the portable terminal 50 and the authorized terminal authentication information stored in self-apparatus (Step S54) (also see FIG. 21).

Then, when it is determined that the terminal authentication performed in the MFP 10 is successful (Step S55), the MFP 10 determines whether or not the requesting terminal (portable terminal 50) of the login request has a biometric authentication function, on the basis of the terminal management table 300 (see FIG. 10) (Step S56).

When it is determined that the requesting terminal (portable terminal 50) of the login request has a biometric authentication function, the process goes to Step S57 and the biometric authentication request is transmitted from the MFP 10 to the portable terminal 50 (also see FIG. 21).

The portable terminal 50 performs the biometric authentication (herein, the fingerprint authentication) in response to the biometric authentication request from the MFP 10 (Step S46) and transmits the biometric authentication result to the MFP 10 (Steps S48 and S49). Specifically, when the biometric authentication is successful, the biometric authentication result indicating that the biometric authentication is successful is transmitted to the MFP 10 (Step S48), and when the biometric authentication fails, the biometric authentication result indicating that the biometric authentication fails is transmitted to the MFP 10 (Step S49).

When the MFP 10 receives the biometric authentication result from the portable terminal 50 (Step S58), the MFP 10 determines whether or not the biometric authentication of the carrying user of the portable terminal 50 is successful (Step S59). The processes of Steps S59 to S61 are the same as those of Steps S27 to S29 in FIG. 8. Specifically, it is determined in Step S59 that the biometric authentication is successful, the login to the MFP 10 is permitted (Step S60) (also see FIG. 21). On the other hand, it is determined in Step S59 that the biometric authentication fails, the login to the MFP 10 is rejected (Step S61).

Further, when it is determined that the requesting terminal of the login request has no biometric authentication function on the basis of the terminal management table 300, the process goes to Step S63 and the manual input authentication is performed, instead of the biometric authentication. The processes of Steps S63 to S65 are the same as those of Steps S34 to S36 in FIG. 8 (see the first preferred embodiment).

In such an exemplary case, it is possible to produce the same effects as those of the above-described first preferred embodiment.

In the above-described fourth preferred embodiment, though the modification of changing the order of execution between the terminal authentication and the biometric authentication is made with respect to the first preferred embodiment, this is only one exemplary case. For example, the same modification (in detail, the modification of performing the biometric authentication after the terminal authentication) may be made with respect to any other preferred embodiment (the second or third preferred embodiment) or the like.

### 5. Variations, etc

Though the preferred embodiments of the present invention have been described above, the present invention is not limited to the above-described exemplary cases.

For example, in the above-described preferred embodiments and the like, the exemplary case where when the biometric authentication fails (Steps S27 (FIG. 8) and S59 (FIG. 20)), the login to the MFP 10 is rejected has been described. The present invention, however, is not limited to this case, when the biometric authentication fails, the manual input authentication may be performed.

Specifically, in Step S27 in FIG. 8 (Step S59 (FIG. 20) in the fourth preferred embodiment), when it is determined that the biometric authentication of the carrying user of the portable terminal 50 fails, the carrying user (operating user) is requested to input the manual input authentication information. Then, when the manual input authentication based on the manual input authentication information inputted by the carrying user is successful, the login to the MFP 10 is permitted (Steps S28 (FIGS. 8) and S60 (FIG. 20)). In other words, even if the biometric authentication performed in the portable terminal 50 fails, when the terminal authentication is successful and the manual input authentication is also successful, the login to the MFP 10 may be (exceptionally) permitted.

Herein, there is a possible case where though the authorized user of the portable terminal 50 (herein, the user U1) operates (has) his own portable terminal 50, the biometric authentication accidentally fails due to the authentication accuracy of the biometric authentication, and the like. In this case, in the above-described preferred embodiments and the like, the login to the MFP 10 by the authorized user is rejected.

In contrast to this, in the above variation, when the biometric authentication fails, the manual input authentication is performed, and the login to the MFP 10 is permitted on the condition that the terminal authentication is successful and the manual input authentication is also successful. In other words, even if the biometric authentication of the authorized user accidentally fails, when the manual input authentication is successful as well as the terminal authentication, the login to the MFP 10 by the authorized user is permitted. Therefore, it is possible to prevent the login by the authorized user from being rejected.

Further, in the above-described preferred embodiments and the like, though the exemplary case where the biometric authentication is performed in response to the biometric authentication request from the MFP 10 (or the external server 80) has been described, this is only one exemplary case. For example, even when the biometric authentication request from the MFP 10 (or the external server 80) is not received, the biometric authentication may be performed at a predetermined timing (for example, automatically performed at a timing when the portable terminal 50 detects the proximity to the MFP 10). Specifically, when the portable terminal 50 detects the proximity to the MFP 10, the portable terminal 50 determines whether or not the self-device has a biometric authentication function, and when the self-device has a biometric authentication function, the portable terminal 50 may automatically perform the biometric authentication.

Furthermore, in the above-described preferred embodiments and the like, though the exemplary case where the terminal management table 300 (FIG. 10) is stored in an internal memory of the determination apparatus (the MFP 10 in the first, second, and fourth preferred embodiments or the external server 80 in the third preferred embodiment) for determining whether or not the requesting terminal of the login request has a biometric authentication function has been described, this is only one exemplary case. For example, the terminal management table 300 may be stored in a device (another server or the like) which is provided separately from the determination apparatus.

Further, in the above-described preferred embodiments and the like, though the exemplary case where whether or not the requesting terminal of the login request has a biometric authentication function is determined on the basis of the terminal management table 300 (FIG. 10) and the model information transmitted from the portable terminal 50 (Steps S22 (FIGS. 8) and S56 (FIG. 20)) has been described, this is only one exemplary case. There may be another case, for example, where the portable terminal 50 transmits the information (biometric authentication function information) on whether or not the self-device has a biometric authentication function to the MFP 10 (or the external server 80) and whether or not the requesting terminal (portable terminal 50) of the login request has a biometric authentication function is determined on the basis of the biometric authentication function information transmitted from the portable terminal 50.

Furthermore, in the above-described preferred embodiments and the like, the number of failures in the biometric authentication may be also used as information for determination on whether to permit the login to the MFP 10.

Specifically, the portable terminal 50 counts the number of failures in the biometric authentication processes performed in response to the biometric authentication request from the MFP 10 (or the external server 80), and transmits the number of failures, together with the biometric authentication result, to the MFP 10 (or the external server 80). For example, when the biometric authentication fails four times and the fifth biometric authentication is successful, the number of failures (herein, four) in the biometric authentication is transmitted, together with the biometric authentication result indicating that biometric authentication is successful, from the portable terminal 50 to the MFP 10 (or the external server 80). The MFP 10 (or the external server 80) acquires (receives) the number of failures (four) from the portable terminal 50, and determines whether the number of failures (four) in the biometric authentication is larger than a predetermined number (e.g., three) or not. Then, even when the biometric authentication result indicating that biometric authentication is successful is received from the portable terminal 50, when the number of failures (four) in the biometric authentication is larger than the predetermined number (three), the MFP 10 rejects the login to the self-apparatus. In other words, the MFP 10 (or the external server 80) permits the login to the MFP 10 on the condition that the number of failures in the biometric authentication is smaller than the predetermined number, as well as the condition that the terminal authentication is successful and the biometric authentication is also successful. Thus, the number of failures in the biometric authentication may be also used as the information for determination on whether to permit the login to the MFP 10.

Further, in the above-described preferred embodiments and the like, though the exemplary case where the terminal authentication is performed in the determination apparatus (the MFP 10 in the first, second, and fourth preferred embodiments or the external server 80 in the third preferred embodiment) for determining whether to permit the login to the MFP 10 has been described, this is only one exemplary case. For example, the terminal authentication may be performed in a device (another server or the like) which is provided separately from the determination apparatus. When the terminal authentication is performed in a device different from the determination apparatus, the determination apparatus acquires (receives) the authentication result of the terminal authentication (the terminal authentication result) from the different device and determines whether to permit the login by using the terminal authentication result.

Further, though the exemplary case where the biometric authentication is performed in the portable terminal 50 has been described in the above-described preferred embodiments and the like, this is only one exemplary case and the biometric authentication may be performed in the MFP 10 (or the external server 80).

Specifically, the MFP 10 (or the external server 80) stores (registers) therein the biometric authentication information of the authorized user to be used in the biometric authentication, in advance. Then, the acquisition part 11 and the authentication part 14 in the MFP 10 (the acquisition part 91 and the authentication part 94 in the external server 80) receive, from the portable terminal 50, the biometric authentication information acquired from the carrying user of the portable terminal 50, and check the biometric authentication information against the biometric authentication information of the authorized user, which is stored in self-apparatus, to thereby perform the biometric authentication. When the biometric authentication is performed, the acquisition part 11 of the MFP 10 (the acquisition part 91 of the external server 80) acquires the authentication result of the biometric authentication (the biometric authentication result). Then, the login to the MFP 10 is permitted on the condition that the terminal authentication is successful in the MFP 10 (or the external server 80) and the biometric authentication is also successful in the MFP 10 (or the external server 80). Thus, the biometric authentication may be performed in the MFP 10 (or the external server 80).

Further, though the exemplary case where the BLE communication is used for the communication between the portable terminal 50 and the MFP 10 has been described in the above-described preferred embodiments and the like, this is only one exemplary case and other wireless communication technologies may be used for the communication between the portable terminal 50 and the MFP 10. For the communication between the portable terminal 50 and the MFP 10, for example, an NFC (Near Field Communication) may be used, or a communication with wireless LAN may be used.

While the invention has been shown and described in detail, the foregoing description is in all aspects illustrative and not restrictive. It is therefore understood that numerous modifications and variations can be devised without departing from the scope of the invention.

What is claimed is:

1. A communication apparatus capable of determining whether to permit a login to an image forming apparatus by a carrying user of a portable terminal, comprising:
an acquisition part for acquiring an authentication result of a terminal authentication performed on the basis of terminal authentication information stored in said portable terminal and authorized terminal authentication information and receiving, from said portable terminal, an authentication result of a biometric authentication which is performed in said portable terminal on the basis of biometric authentication information acquired from said carrying user of said portable terminal and biometric authentication information of an authorized user of said portable terminal; and
a permission part for permitting said login to said image forming apparatus by said carrying user on the condition that said terminal authentication is successful and said authentication result indicating that said biometric authentication is successful is received from said portable terminal.

2. The communication apparatus according to claim 1, wherein
said acquisition part transmits a biometric authentication request for requesting execution of said biometric authentication by said portable terminal to said portable terminal and receives, from said portable terminal, said authentication result of said biometric authentication which is performed in said portable terminal in response to said biometric authentication request.

3. The communication apparatus according to claim 1, wherein
said acquisition part transmits biometric authentication type information instructing that a specific type of biometric authentication among a plurality of types of biometric authentications should be performed, to said portable terminal.

4. The communication apparatus according to claim 3, wherein
said specific type of biometric authentication is set for each of users of said image forming apparatus, and
said biometric authentication type information is information instructing that a type of biometric authentication should be performed, which is set for a user who is one of said users of said image forming apparatus and said authorized user of said portable terminal, among said plurality of types of biometric authentications.

5. The communication apparatus according to claim 1, wherein
said acquisition part transmits authentication accuracy information specifying a predetermined set value on an authentication accuracy in said biometric authentication, to said portable terminal.

6. The communication apparatus according to claim 5, wherein
said predetermined set value is set for each of users of said image forming apparatus, and
said authentication accuracy information is information specifying a set value which is set for a user who is one of said users of said image forming apparatus and said authorized user of said portable terminal, as said predetermined set value.

7. The communication apparatus according to claim 2, wherein
said acquisition part determines whether said portable terminal has a biometric authentication function or not, and
transmits said biometric authentication request to said portable terminal when it is determined that said portable terminal has said biometric authentication function.

8. The communication apparatus according to claim 7, wherein
said acquisition part receives model information of said portable terminal from said portable terminal, and
determines whether said portable terminal has said biometric authentication function or not, on the basis of management information for managing whether said portable terminal has said biometric authentication function or not, for each terminal model, and said model information received from said portable terminal.

9. The communication apparatus according to claim 7, wherein
said acquisition part receives biometric authentication function information on whether said portable terminal has said biometric authentication function or not, from said portable terminal, and determines whether said portable terminal has said biometric authentication function or not, on the basis of said biometric authentication function information received from said portable terminal.

10. The communication apparatus according to claim 7, wherein
said permission part requests said carrying user of said portable terminal to perform a manual input of manual input authentication information used for a manual input authentication which is an authentication requiring a manual input of authentication information when it is determined that said portable terminal does not have said biometric authentication function, and
permits said login on the condition that said terminal authentication is successful and said manual input authentication is also successful, which is performed on the basis of manual input authentication information inputted by said carrying user and authorized manual input authentication information.

11. The communication apparatus according to claim 2, wherein
the necessity/unnecessity of said biometric authentication is set for each of users of said image forming apparatus, and
said acquisition part transmits said biometric authentication request to said portable terminal when the necessity of said biometric authentication is set for a user who is one of said users of said image forming apparatus and said authorized user of said portable terminal, and
does not transmit said biometric authentication request to said portable terminal when the unnecessity of said biometric authentication is set for a user who is one of said users of said image forming apparatus and said authorized user of said portable terminal.

12. The communication apparatus according to claim 11, wherein
said permission part requests said carrying user of said portable terminal to perform a manual input of manual input authentication information used for a manual input authentication which is an authentication requiring a manual input of authentication information when said biometric authentication request is not transmitted to said portable terminal, and
permits said login on the condition that said terminal authentication is successful and said manual input authentication is also successful, which is performed on the basis of manual input authentication information inputted by said carrying user and authorized manual input authentication information.

13. The communication apparatus according to claim 1, wherein
said permission part requests said carrying user of said portable terminal to perform a manual input of manual input authentication information used for a manual input authentication which is an authentication requiring a manual input of authentication information when said biometric authentication fails, and
permits said login when said terminal authentication is successful and said manual input authentication is also successful, which is performed on the basis of manual input authentication information inputted by said carrying user and authorized manual input authentication information, even if said biometric authentication fails.

14. The communication apparatus according to claim 1, wherein
said permission part rejects said login when said biometric authentication fails.

15. The communication apparatus according to claim 1, wherein
said acquisition part acquires the number of failures in said biometric authentication, and
said permission part rejects said login when said number of failures is larger than a predetermined number, even if said biometric authentication is successful.

16. The communication apparatus according to claim 1,
said communication apparatus being said image forming apparatus.

17. The communication apparatus according to claim 1,
said communication apparatus being an external server provided separately from said image forming apparatus.

18. A communication system, comprising:
a communication apparatus as defined in claim 1; and
said portable terminal.

19. A non-transitory computer-readable recording medium for recording therein a computer program to be executed by a computer embedded in a communication apparatus capable of determining whether to permit a login to an image forming apparatus by a carrying user of a portable terminal, to cause said computer to perform the steps of:
a) acquiring an authentication result of a terminal authentication performed on the basis of terminal authentication information stored in said portable terminal and authorized terminal authentication information and receiving, from said portable terminal, an authentication result of a biometric authentication which is performed in said portable terminal on the basis of biometric authentication information acquired from said carrying user of said portable terminal and biometric authentication information of an authorized user of said portable terminal; and
b) permitting said login to said image forming apparatus by said carrying user on the condition that said terminal authentication is successful and said authentication result indicating that said biometric authentication is successful is received from said portable terminal.

20. A communication apparatus capable of determining whether to permit a login to an image forming apparatus by a carrying user of a portable terminal, comprising:
an acquisition part for acquiring an authentication result of a terminal authentication performed on the basis of terminal authentication information stored in said portable terminal and authorized terminal authentication information and acquiring an authentication result of a biometric authentication performed in said communication apparatus on the basis of biometric authentication information received from said portable terminal, which is biometric authentication information acquired from said carrying user of said portable terminal, and biometric authentication information of an authorized user of said portable terminal; and
a permission part for permitting said login to said image forming apparatus by said carrying user on the condition that said terminal authentication is successful and said biometric authentication is also successful.

21. A communication system, comprising:
a communication apparatus as defined in claim 20; and
said portable terminal.

22. A non-transitory computer-readable recording medium for recording therein a computer program to be executed by a computer embedded in a communication apparatus capable of determining whether to permit a login to an image forming apparatus by a carrying user of a portable terminal, to cause said computer to perform the steps of:
a) acquiring an authentication result of a terminal authentication performed on the basis of terminal authentication information stored in said portable terminal and authorized terminal authentication information and acquiring an authentication result of a biometric authentication performed in said communication apparatus on the basis of biometric authentication information received from said portable terminal, which is biometric authentication information acquired from said carrying user of said portable terminal, and biometric authentication information of an authorized user of said portable terminal; and
b) permitting said login to said image forming apparatus by said carrying user on the condition that said terminal authentication is successful and said biometric authentication is also successful.
